(19) United States
(12) Patent Application Publication
(10) Pub. No.: US 2013/0246686 A1
(43) Pub. Date: Sep. 19, 2013

(54) STORAGE SYSTEM COMPRISING NONVOLATILE SEMICONDUCTOR STORAGE DEVICE, AND STORAGE CONTROL METHOD

(71) Applicants: Yoshiyuki Noborikawa, Sagamihara (JP); Yoshihiro Oikawa, Kaisei (JP)

(72) Inventors: Yoshiyuki Noborikawa, Sagamihara (JP); Yoshihiro Oikawa, Kaisei (JP)

(73) Assignee: Hitachi, Ltd.

(21) Appl. No.: 13/502,434

(22) PCT Filed: Mar. 19, 2012
(86) PCT No.: PCT/JP12/01905

§ 371 Date: Apr. 17, 2012

(51) Int. Cl. G06F 12/02

(52) U.S. Cl. 711/102; 711/E12.007

(57) ABSTRACT

A higher-level system of a nonvolatile semiconductor storage device (hereinafter, semiconductor device) displays a GUI (Graphical User Interface), which receives a parameter group (one or more parameters) for controlling the processing of the semiconductor device. The higher-level system stores at least one of the parameters of the parameter group inputted to the GUI, and sends a command comprising the parameter group to the semiconductor device. The semiconductor device stores at least one of the parameters of the parameter group included in this command. The higher-level system and the semiconductor device each execute processing in accordance with the stored parameter. The semiconductor device sends, to the higher-level system, information of a log related to the processing executed in accordance with the stored parameter. The higher-level system displays feedback information on the basis of multiple times of logs. A user can change a desired parameter on the basis of this feedback information.

### TECHNICAL FIELD

The present invention relates to the control of a nonvolatile semiconductor storage device.

### BACKGROUND ART

Storage devices used in a storage system, for example, include a HDD (Hard Disk Drive) and a SSD (Solid State Drive).

The characteristic features of a storage device will differ in accordance with the type of storage device. As types of HDD, for example, there are the SAS (Serial Attached SCSI)-HDD and the SATA (Serial ATA)-HDD, the SAS-HDD comprising the characteristic features of high reliability and high performance, and the SATA-HDD comprising the characteristic feature of large capacity. Meanwhile, in comparison to the HDD, the SSD comprises the characteristic features of high performance, outstanding shock resistance, and low standby power consumption.

Technology for the hierarchization of data (referred to as data hierarchization technology hereinafter) may be applied to a storage system, and in accordance with this, storage devices with different characteristic features, such as the HDD and the SSD, may be used in the same storage system.

In data hierarchization technology, for example, a first tier is formed using a high-performance storage device (for example, a SSD), a second tier is formed using a medium-performance storage device (for example, a SAS-HDD), and a third tier is formed using a low-performance storage device (for example, a SATA-HDD). Then, in the data hierarchization technology, a storage system controller (referred as a storage controller hereinafter), for example, stores frequently accessed data in the first tier, stores infrequently accessed data in the third tier, and stores all other data in the second tier. Thus, in the data hierarchization technology, the storage controller decides the tier for storing the respective data in accordance with the frequency with which the data is accessed.

As described above, in the data hierarchization technology, the SSD may be used primarily as a high-performance storage device, but, for example, an SSD, which uses NAND-type flash memory (referred to as a NAND-SSD hereinafter) generally has the following restrictions (Patent Literature 1 and 2).

(1) A NAND-SSD is a recordable memory in which data is not able to be overwritten.
(2) The read/write unit (page) and the erase unit (block) differ.
(3) There are restrictions on the number of data erases.
(4) There are restrictions on the data retention period.

The restrictions mentioned in (1) and (2) above, for example, may lower the performance of the NAND-SSD. To store recorded data (for example, new write data and/or updated data (hereinafter new/updated write data)), a free block (a block comprising only writable pages) is essential. New write data, as used here, is data to be newly written to the NAND-SSD. Updated write data is post-update data with respect to data, which has already been written to the NAND-SSD.

When free blocks run out, the NAND-SSD is no longer able to store new/updated write data. For this reason, the NAND-SSD performs a reclamation process, that is, the NAND-SSD migrates valid data from a block in which the capacity is full of new/updated write data (referred to as the target block hereinafter) to another block, and erases the data stored in the target block. In accordance with this, the target block becomes a free block.

However, when the reclamation process is performed frequently, there may be cases in which a load is placed on the NAND-SSD, making it impossible to maintain the performance of the NAND-SSD.

As used here, valid data is the latest data (that is, new write data or the latest updated write data). Invalid data is pre-update write data corresponding to the latest updated write data (old new write data or updated write data, which is still being stored in a block without being erased).

A physical area of an SSD (a block group) is generally partitioned into a user area and a reserved area. The user area is generally allocated to a logical area, and is an area in which data from a device controller (a controller coupled to an SSD or other such storage device) is stored, and the reserved area is an area other than the user area, and, for example, is comprised from multiple free blocks. When numerous reserved areas are secured, free blocks (buffers) for receiving new/updated write data increase by that much, making it possible to maintain the peak performance period of the SSD (for example, the time period during which response performance is high).

The restrictions mentioned in (3) and (4) above are related to the life of the NAND-SSD and other such SSDs. In particular, the number of erases (the number of times data is erased from a block) is an important parameter since the incidence of errors rises when the number of erases reaches an upper limit. In the following explanation, a block with a relatively small number of erases will be called a young block, and a block with a relatively large number of erases will be called an old block.

Generally speaking, when data is stored in an old block, the incidence of errors (for example, data retention, write disturb, read disturb) rises. Consequently, the NAND-SSD performs refresh on a regular (or irregular) basis, that is, reads data from an old block, corrects the errors, and migrates the error-corrected data to a young block (refresh process).

### CITATION LIST

### Patent Literature

PTL 1: Japanese Patent Application Laid-open No. 2008-009594
PTL 2: Japanese Patent Application Laid-open No. 2006-23815

### SUMMARY OF INVENTION

### Technical Problem

A SSD generally costs more to install than a HDD. For this reason, when installing a SSD in a storage system, it is preferable that the system be meticulously planned, and an estimate be made as to the SSD requirements and number of SSDs needed. However, in designing a complex system such as data hierarchization technology, the estimates made at system design time could change at system installation. In a case where the SSD requirements change, it becomes necessary to take such steps as increasing the budget to cover installation costs and changing to a different SSD, or revising the number of SSD units to be installed.

In addition, as mentioned above, the SSD is a limited-life storage device. Therefore, after using a SSD for a fixed period of time in a high-performance application, there is the likelihood of large numbers of old blocks existing in this SSD, and of the incidence of errors increasing. An SSD having large numbers of old blocks lacks reliability, and as such, for example, cannot be installed in the low-access-frequency layer in the data hierarchization technology. It is preferable that a SSD such as this be destroyed due to its low reliability, but in a case where the utilization period of an SSD slated for destruction has not reached the end-of-life for this SSD, it will probably be necessary to budget for additional amortization costs.

Generally speaking, the SSD also suffers fewer failures resulting from hardware defects than the HDD. For this reason, for the SSD, “remaining life” is an important index for deciding the SSD replacement time. It is possible to find the “remaining life down slope” based on the current utilization status (the use application to date), and to estimate the life of the SSD from this slope. However, in a case where the SSD application changes part way through its use, the use application to date will differ from the use application from here on out. Therefore, it becomes impossible to decide the SSD replacement time based solely on the “remaining life down slope” determined on the basis of the use application to date.

Problems such as those described hereinabove are also possible with respect to a non-volatile semiconductor storage device (hereinafter, nonvolatile device) other than an SSD.

### Solution to Problem

A storage system comprises a nonvolatile semiconductor storage device, and a higher-level system coupled to this semiconductor storage device. The semiconductor storage device comprises a nonvolatile semiconductor storage medium, and a medium controller, which is a controller coupled to the semiconductor storage medium. The medium controller receives an I/O (Input/Output) command, and either writes or reads data to/from the semiconductor storage medium in accordance with this I/O command.

(A) A parameter setting process comprising the following (a1) through (a4) is executed.

(a1) The higher-level system displays a GUI (Graphical User Interface) for receiving a first parameter group, which is one or more parameters for controlling semiconductor storage device processing.

(a2) The higher-level system stores a second parameter group, which is at least one of the parameters of the first parameter group inputted to the GUI.

(a3) The higher-level system creates a parameter setting command, which is a command comprising a third parameter group which is at least one of the parameters of the first parameter group, and sends the parameter setting command to the semiconductor storage device.

(a4) The medium controller receives the parameter setting command and stores a fourth parameter group, which is at least one of the parameters of the third parameter group included in the parameter setting command.

(B) The higher-level system executes processing in accordance with at least one of the parameters of the stored second parameter group.

(C) The medium controller executes processing in accordance with at least one of the parameters of the stored fourth parameter group.

(D) A log provision process comprising the following (d1) and (d2) is executed on either a regular or irregular basis.

(d1) The medium controller sends, to the higher-level system, a first log information comprising a first log, which is one or more types of logs related to a process executed in accordance with at least one of the parameters of the stored fourth parameter group.

(d2) The higher-level system receives the first log information and stores a second log group, which is based on the first log group included in the first log information.

(E) The higher-level system displays feedback information, which is information based on multiple second log groups, which have been stored.

The above-described (A) is performed with respect to a user-desired parameter of the first parameter group after (E) described above.

### BRIEF DESCRIPTION OF DRAWINGS

FIG. 1 shows an example of the configuration of a storage system related to Example 1.

FIG. 2 shows an example of programs and information stored in a memory of a management computer related to Example 1.

FIG. 3 shows an example of programs and information stored in a memory of a storage controller related to Example 1.

FIG. 4 shows an example of programs and information stored in a memory of an FM controller related to Example 1.

FIG. 5 shows an example of a mode management table related to Example 1.

FIG. 6 shows an example of a life management table related to Example 1.

FIG. 7 shows an example of a schedule management table related to Example 1.

FIG. 8 shows an example of a RG management table related to Example 1.

FIG. 9 shows an example of a schedule management table related to Example 1.

FIG. 10 shows an example of a schedule configuration information management table related to Example 1.

FIG. 11 shows an example of a schedule statistical information management table related to Example 1.

FIG. 12 shows an example of a FM package configuration information management table related to Example 1.

FIG. 13 shows an example of a FM package statistical information management table related to Example 1.

FIG. 14 shows an example of a SCSI MODE SELECT related to Example 1.

FIG. 15 shows an example of a LOG SENSE related to Example 1.

FIG. 16 shows an example of the relationship between a size of an FM package reserved area and a degree of deterioration of a response performance of the FM package 40 related to Example 1.

FIG. 17 shows an example of the flow of processing for creating a LU and a RG related to Example 1.

FIG. 18 shows an example of the flow of a write process by the storage controller related to Example 1.

FIG. 19 shows an example of the flow of a write process by the FM controller related to Example 1.

FIG. 20 is a schematic diagram denoting exchanges among apparatuses related to Example 1.

FIG. 21 shows an example of the flow of a parameter reflection process by the management computer related to Example 1.

FIG. 22 shows an example of the flow of a parameter reflection process by the storage controller related to Example 1.

FIG. 23 shows an example of the flow of a parameter reflection process by the FM package related to Example 1.

FIG. 24 shows an example of the flow of a log information acquisition process by the management computer related to Example 1.

FIG. 25 shows an example of the flow of a log information acquisition process by the storage controller related to Example 1.

FIG. 26 shows an example of the flow of a log information acquisition process by the FM package related to Example 1.

FIG. 27 shows an example of the flow of a parameter group related to Example 1.

FIG. 28 shows an example of a RAID group creation screen related to Example 1.

FIG. 29 shows an example of a mode change screen related to Example 1.

FIG. 30 shows an example of a life display screen related to Example 1.

FIG. 31 shows an example of the flow of a RC scheduling process related to Example 1.

FIG. 32 shows an example of the flow of processing of S313 (performance determination process) of FIG. 31.

FIG. 33 shows an example of the flow of a RC process by the FM controller related to Example 1.

FIG. 34 shows an example of the flow of a RF cyclical execution process by the FM controller related to Example 1.

FIG. 35 shows an example of the flow of processing of S345 (RF process) of FIG. 34.

FIG. 36 shows an example of the flow of a reserved area setting process related to Example 1.

FIG. 37 shows an example of the configuration of a storage system related to Example 2.

FIG. 38 shows an example of the configuration of a storage system related to Example 3.

### DESCRIPTION OF EMBODIMENTS

A number of examples will be explained below. In this explanation, various information may be explained using the expression “xxx table”, but the various information may be expressed using a data structure other than a table. The “xxx table” can be called “xxx information” to show that the various information is not dependent on the data structure.

In the following explanation, a number is used as the identification information of an element (for example, a page), but a different type of identification information (for example, a name or an identifier) may be used.

In the following explanation, a flash memory is abbreviated as “FM”, a RAID group is abbreviated as “RG”, a reclamation is abbreviated as “RC”, and a refresh is abbreviated as “RF”.

In addition, in a case where processing is explained using a “program” as the doer of the action, since the stipulated processing is performed in accordance with the program being executed by a processor (for example, a CPU (Central Processing Unit)), which comprises a controller (a storage controller and a FM controller), while using a storage resource (for example, a memory) and/or a communication interface device (for example, a communication port) as needed, the processor may also be used as the doer of the processing. Furthermore, the controller (the storage controller and the FM controller) may comprise a hardware circuit, which performs either part or all of the processing. A computer program may be installed from a program source. The program source, for example, may be either a program delivery server or a computer-readable storage medium.

The storage medium of the nonvolatile semiconductor storage device is explained hereinbelow as being an FM, but the storage medium may be a different type of storage medium (for example, a phase-change memory).

A management system may comprise one or more computers. Specifically, for example, in a case where a management computer comprises a display device and displays information on this display device, or, in a case where a remote computer comprises a display device and information is displayed on the display device of the remote computer in accordance with the management computer sending display information to this remote computer, the management computer is the management system. Also, for example, in a case where the same functions as those of the management computer are realized using multiple computers, the relevant multiple computers (may include a display computer when a display is performed by the display computer) are the management system. In the embodiment, the management computer is the management system. Furthermore, the act of “displaying” by a computer (or a control device (for example, a processor) of the computer) may be both an act in which the computer displays information on the display device of this computer, and an act in which the computer sends information to be displayed to a different computer, which comprises a display device, to be displayed on this display device.

In the following explanation, a portion of a reference sign shared in common by like elements will be used when explaining the like elements, and an entire reference sign will be used when providing an explanation that distinguishes between the like elements.

### Example 1

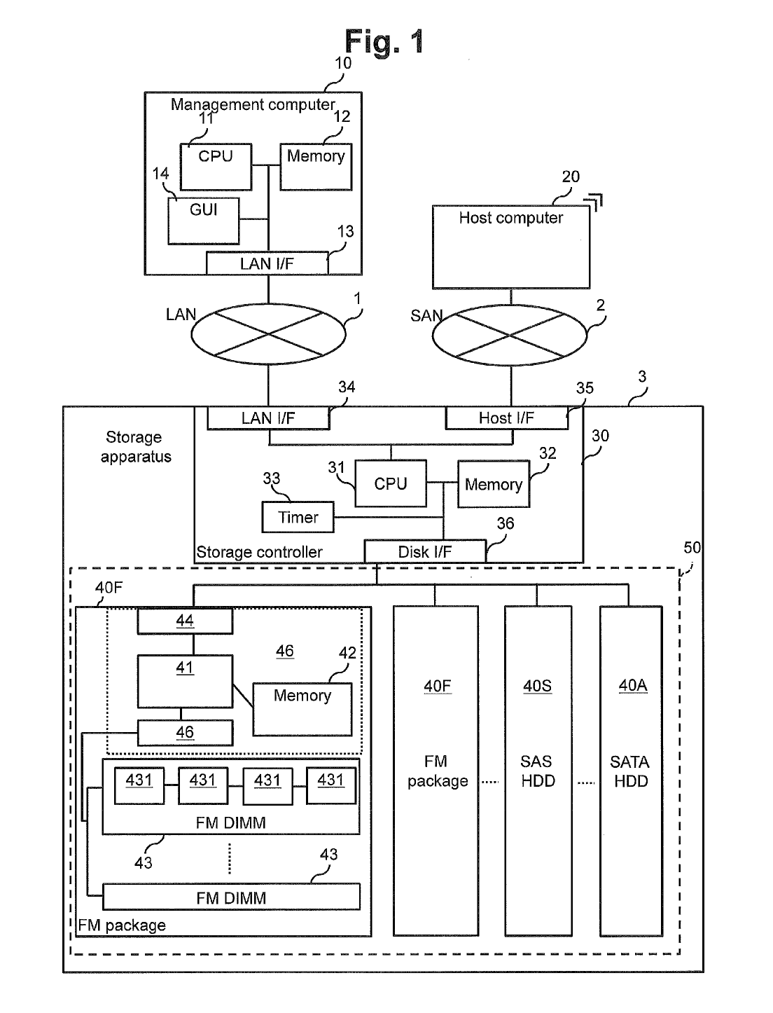

FIG. 1 shows an example of the configuration of a storage system related to Example 1.

The storage system comprises a management computer 10 and a storage apparatus 3. The storage apparatus 3 comprises a storage part 50 and a storage controller 30 coupled to the storage part 50. The storage part 50 comprises multiple storage devices 40. The management computer 10 and a host computer 20 are coupled to the storage controller 30. In this example, a higher-level system with respect to a FM module 40, which will be described further below, may be a system comprised of the storage controller 30 and the management computer 10.

The management computer 10 and the storage controller 30 are communicably coupled via a first communication network (for example, a LAN (Local Area Network) 1). The host computer 20 and the storage controller 30 are communicably coupled via a second communication network (for example, a SAN (Storage Area Network) 2). The first and second communication networks may be integrated together.

The management computer 10 comprises a communication interface, a storage device, and a control device coupled thereto. As the communication interface, for example, there is a LAN I/F (Inter/Face) 13. As the storage device, for example, there is a memory 12. As the control device, for example, there is a CPU (Central Processing Unit) 11 and a GUI (Graphical User Interface) 14.

The memory 12 stores information and a program for managing the storage system. The CPU 11 realizes various functions in accordance with executing the program stored in the memory 12. The LAN I/F 13 is a communication interface device for coupling the management computer 10 to the storage controller 30. The management computer 10 is coupled to the storage controller via the LAN 1 and the LAN I/F 13. The management computer 10 displays the GUI 14, which will be described further below.

The host computer 20 is an example of a device controller, which uses the storage device 40. The host computer 20, for example, is an application server.

The storage controller 30 comprises a communication interface, a storage device, and a control device, which is coupled thereto. As communication devices, for example, there is a LAN I/F 34, a host I/F 35, and a Disk I/F 36. As the storage device, for example, there is a memory 32. The control device, for example, comprises a CPU 31 and a timer 33.

The memory 32 stores information and a program for controlling the storage part 50. The CPU 31 realizes various types of functions in accordance with executing the program stored in the memory 32.

The timer 33 is used for managing a current time and an elapsed time. For example, using the timer 33, the CPU 31 is able to control the triggers for executing the various types of programs, and learn the elapsed time from the start of a RC (RC) up until the next RC is performed.

The LAN I/F 34 is a communication interface for coupling the storage controller 30 to the management computer 10. The host I/F 35 is a communication interface for coupling the storage controller 30 to the host computer 20. The Disk I/F 36 is a communication interface for coupling the storage controller 30 to the respective storage devices 40. The word “Disk” has been used here for the sake of convenience, but this does not signify that the storage device 40 is always a disk-type storage device like a HDD. The storage device 40 may be a type of storage device other than a disk-type storage device.

As the storage devices 40 there is a FM package 40F, a SAS (Serial Attached SCSI)-HDD 40S, and a SATA (Serial ATA)-HDD 40A. An RG may be configured using the same type of storage device 40. Data is stored in the RG in accordance with a prescribed RAID level.

The FM package 40F will be explained below.

The FM package 40F comprises multiple FM DIMM 43, which comprise FM (flash memory), and a FM controller 45, which is coupled to the storage controller and the multiple FM DIMM 43.

The FM controller 45 controls the FM package 40F. The FM controller 45 comprises a communication interface device, a storage device, and a FM control device 41 coupled thereto. As the communication interface devices, for example, there is a disk I/F 44, which is coupled to the storage controller, and a FM I/F 46, which is coupled to the DIMM 43. As the storage device, for example, there is a memory 42. The FM control device 41, for example, comprises a CPU. A control device may comprise a circuit for coding data to be written to the FM, a circuit for decoding coded data, which has been read from the FM, a circuit for compressing data to be written to the FM, and a circuit for decompressing compressed data (data, which has been compressed), which has been read from the FM.

The memory 42 stores information and a program for controlling a FM package 40F. The FM control device 41 realizes various types of functions in accordance with executing the program stored in the memory 42. The FM DIMM 43 is comprised from multiple FM chips 431. As the FM chip 431, for example, a NAND-type FM chip may be used.

The storage part 50 is comprised from multiple different types of storage devices 40, and the SAS-HDD 40 and the SATA-HDD 40 are not essential components. In this example, the storage part 50 may be comprised at the least from a FM package 40F.

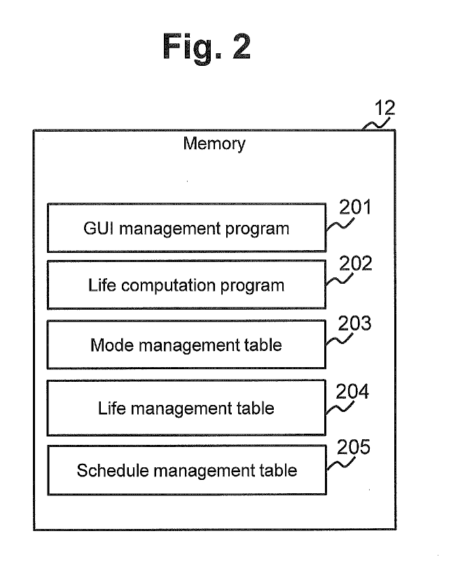

FIG. 2 shows an example of programs and information stored in the memory 12 of the management computer 10.

The memory 12, for example, stores a GUI management program 201, a life computation program 202, a mode management table 203, a life management table 204, and a schedule management table 205.

The GUI management program 201 is for controlling the GUI 14. The GUI 14, for example, is an interface for receiving an information setting related to the configuration of the storage system, a selection of a user-desired mode from among multiple modes, and an input of multiple parameters respectively corresponding to multiple items of a RAID (Redundant Array of Independent (Inexpensive) Disks) group related to the user-desired mode. The mode, item, and parameter will be explained further below.

The life computation program 202 is for computing the life of each RG based on log information acquired from the FM controller 45 by way of the storage controller 30. The log information here is information collected in units of DIMMs by the FM controller 45, and comprises a log related to processing (an operation) performed by this FM package 40F in accordance with a parameter configured in the FM package 40F. The log information is collected using a prescribed unit (for example, a DIMM unit), and, for example, comprises the number of PEs (Program Erase), a PE interval, an EP interval, the number of RD (Read) errors, an IOPS (Input Output Per Second), an operating time since start of utilization, a temperature, a total write quantity (total number of bytes of write data), the number of defective blocks, the number of life blocks, and number of occurrences of uncorrectable errors. The log information collected by the FM controller 45 may not be in units of DIMMs. The IOPS is an example of the access load of the FM package 40F, specifically, for example, the access frequency (the number of I/Os per unit of time (number of accesses)). The access load, for example, may be a response time, which is the time from when the storage controller 30 sends a command until the storage controller 30 receives a response, instead of the TOPS.

The mode management table 203 comprises information related to a parameter group (one or more parameters) and a mode for controlling the operation of the FM package 40F. The parameter group may comprise a parameter, which influences an internal operation (for example, a RC process and a RF process), which is an operation started by the FM package 40F without a command being received from the device controller (the storage controller 30 in this example).

The life management table 204 is for managing log information acquired from the storage controller 30. In this example, this log information is managed by the FM controller 45 in units of DIMMs in the FM package 40F as mentioned hereinabove (refer to FIG. 13).

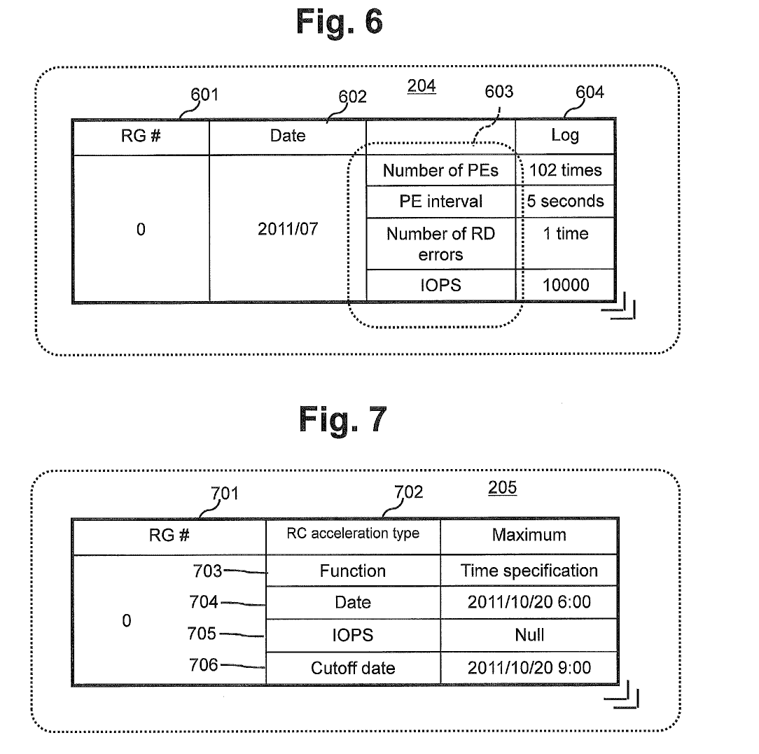

The storage controller 30 (CPU 31) manages the log information in units of FM packages 40F (refer to FIG. 11). The management computer 10 (CPU 11) manages the log information in units of RGs (refer to FIG. 6). The storage controller 30 may manage the log information using a different unit such as units of RGs, and, similarly, the management computer 10 may manage the log information using a different unit, such as units of FM packages 40F.

The schedule management table 205 is for managing schedule information of a RC process specified by the user for each RG.

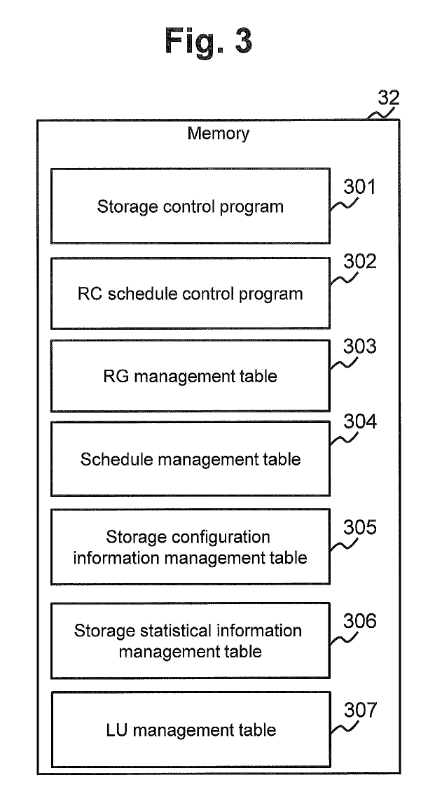

FIG. 3 shows an example of programs and information stored in the memory 32 of the storage controller 30.

The memory 32, for example, stores a storage control program 301, a RC schedule control program 302, a RG management table 303, a schedule management table 304, a storage configuration information management table 305, a storage statistical information management table 306, and a LU (Logical Unit) management table 307.

The storage control program 301 is for controlling the operation of the storage controller 30.

The RC schedule control program 302 is for controlling a RC execution schedule for each RG on the basis of information in the schedule management table 304.

The RG management table 303 is for managing a RG, which is managed by the storage controller 30, and a FM package comprising this RG.

The schedule management table 304 is for managing the RC process schedule.

The storage configuration information management table 305 is for managing a parameter, which can be set for each RG.

The storage statistical information management table 306 is for managing, in FM package units, log information collected by the FM controller 45 in units of DIMMs.

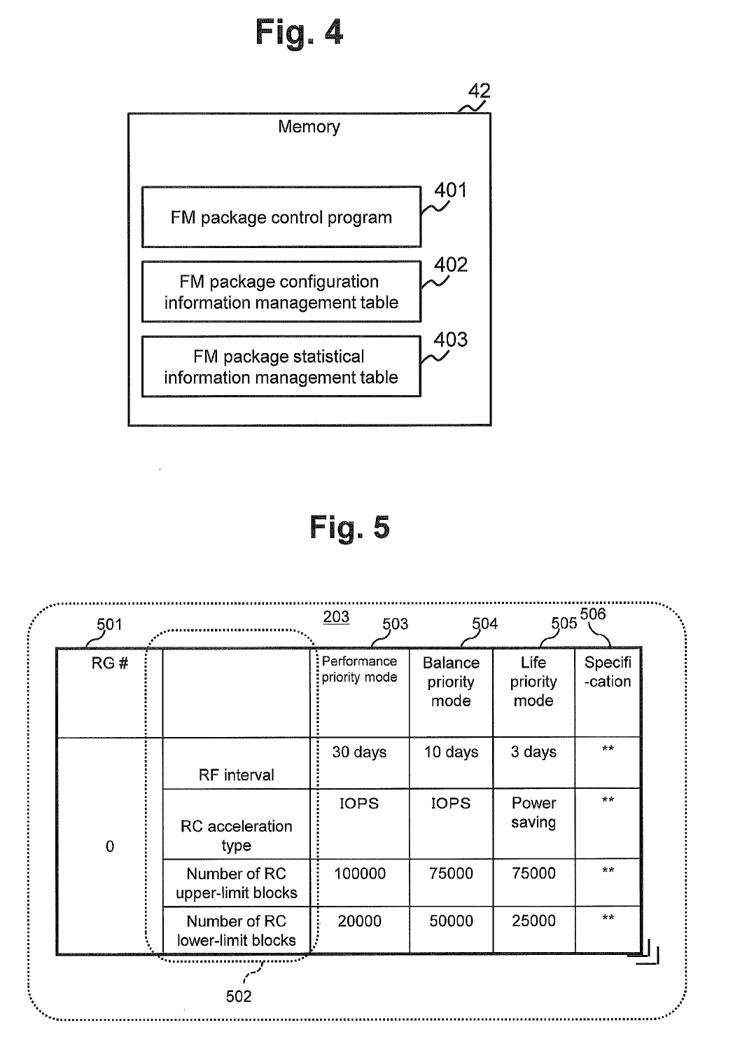

FIG. 4 shows an example of a program and information stored in the memory 42 of the FM controller 45.

The memory 42, for example, stores a FM package control program 401, a FM package configuration information management table 402, and a FM package statistical information management table 403.

The FM package control program 401 is for controlling the FM package as a whole.

The FM package configuration information management table 402 is for managing a parameter, which can be set for each FM package.

The FM package statistical information management table 403 is for managing, in DIMM units, log information collected by the FM controller 45 in units of DIMMs.

FIG. 5 shows an example of the mode management table 203.

The mode management table 203 associatively stores a RG #501, a performance priority mode 503, a balance priority mode 504, a life priority mode 505, and a specification 506 for each RG.

The RG #501 is information for identifying a RG.

The “mode” is the priority for controlling the RG, and one or more items 502 is/are associated with each mode. A parameter is configured for each item 502. The items 502, for example, are a RF (refresh) interval, a RC (reclamation) acceleration type, the number of RC upper-limit blocks, and the number of RC lower-limit blocks.

(*) The RF interval is information denoting an interval for RF processes (for example, the interval between the start time of a RF and the start time of the next RF, or the interval between the end time of a RF process and the start time of the next RF process).

(*) The RC acceleration type is information denoting the timing at which most RC processes are to be performed. For example, “TOPS” signifies that the RC process will start when the TOPS exceeds a first threshold, and “power saving” signifies that the RC process will start when the power consumption exceeds a second threshold. A threshold other than the first and second thresholds by which the TOPS and the power consumption are compared, for example, a threshold by which the elapsed time since a previous RC process is compared, may be used as the threshold referenced when controlling the timing for starting a RC process.

(*) The number of RC upper-limit blocks is an upper limit value for the number of free blocks. In a case where the number of free blocks is larger than the number of RC upper-limit blocks, the RC process is stopped. A free block is a block in which data is not stored in any page, and a used block transitions to a free block in accordance with data being erased from the used block (an erase process being performed with respect to the used block). The “used block” is a block in which data is written from the first page to the last page of the block.

(*) The number of RC lower-limit blocks is a lower limit value of the number of free blocks. In a case where the number of free blocks is smaller than the number of RC lower-limit blocks, the RC process is started.

These four types of parameters are parameters influencing the number of erases of the FM module 40F. That is, since the RF process is performed frequently when the RF interval is short, the number of erases resulting from the RF processes increases rapidly, and alternatively, since the RF process is performed infrequently when the RF interval is long, the number of erases resulting from the RF processes increases slowly. Since the RC process is performed frequently when the RC acceleration type signifies RC acceleration “large”, the number of erases resulting from the RC processing increases rapidly, and alternatively, since the RC process is performed infrequently when the RC acceleration type signifies RC acceleration “small”, the number of erases resulting from the RC processing increases slowly. Since the RC process is performed often when the number of RC upper-limit blocks is large, the number of erases resulting from the RC processing increases rapidly, and alternatively, since the RC process is not performed very often when the number of RC upper-limit blocks is small, the number of erases resulting from the RC processing increases slowly. Since the RC process is started frequently when the number of RC lower-limit blocks is large, the number of erases resulting from the RC processing increases rapidly, and alternatively, since the RC process is not started very often when the number of RC lower-limit blocks is small, the number of erases resulting from the RC processing increases slowly. The parameter influencing the number of erases may be a parameter other than the above-mentioned four types.

The performance priority mode 503 is the mode for controlling the RG such that the performance (for example, the IOPS) is higher compared to the other modes. In the performance priority mode 503, for example, values corresponding to the items 502 are configured so that the performance of the RG becomes higher compared to that of the balance priority mode 504 and the life priority mode 505.

The balance priority mode 504 is the mode for controlling the RG to achieve good balance compared to the other modes. In the balance priority mode, for example, the items 502 are configured so that the performance of the RG is lower than the performance priority mode 503 but higher than the life priority mode 505. In addition, in the balance priority mode 504, for example, values corresponding to the items 502 are configured such that the life of the RG becomes shorter than in the life priority mode 505, and the life of the RG becomes longer than in the performance priority mode 503.

The life priority mode 505 is the mode for controlling the RG such that the life becomes longer compared to the other modes. In the life priority mode 505 values corresponding to the items 502 are configured so that the life of the RG becomes longer compared to that of the performance priority mode 503 and the balance priority mode 504.

The specification 506 is a parameter value individually configured by the user independent of the mode type.

FIG. 6 shows an example of the life management table 204.

The life management table 204 associatively stores a RG #601, a date 602, a log item 603, and a detection result (Log) 604 for each RG.

The RG #601 is information for identifying an RG.

The date 602 is information denoting the date on which log information was acquired. The date is represented as year, month, day, but may be represented in detail down to any of the units of hour, minute and second.

The log item 603 is information denoting an item for recording an operation result for the RG. As the log items 603, for example, there is the number of PEs (may be synonymous with number of erases), a PE interval, the number of RD errors, and an IOPS. The number of PEs is the number of times that an erase process has been performed. The PE interval is the time period from when data is programmed until this data is erased. The PE interval may be the time period from when data is programmed to the initial page of a block until this data is erased, may be the time period from when data is programmed to the last page of a block until this data is erased, and may be an average value of the time period from when data is programmed to each page until this data is erased. The number of RD errors is the number of times that an error has occurred during a read. The IOPS is the access frequency. These values can be measured for each block. These RG values may be based on values for multiple blocks in the RG (for example, an average value).

The Log 604 is a value for each log item 603. For example, according to the example shown in the drawing, the number of PEs is 102, the PE interval is 5 seconds, the number of RD errors is 1, and the IOPS is 10000. In the following explanation, this log item 603 and Log 604 may denote “log information”. That is, the log information, as was described above, is information comprising the result of an FM package 40F operation in accordance with a parameter configured in this FM package 40F, and comprises one or more prescribed log items for each (in the above-described example, the number of PEs, the PE interval, the number of RD errors, and the TOPS).

FIG. 7 shows an example of the schedule management table 205.

The schedule management table 205 correspondingly stores a RG #701, a RC acceleration type 702, a function 703, a date 704, an TOPS 705, and a cutoff date 706 for each RG.

The RG #701 is information for identifying a RG.

The RC acceleration type 702 is information denoting how much to accelerate the execution of the RC. For example, the RC acceleration type 702 is “maximum”, “minimum” or “moderate”. In a case where the RC acceleration type 702 is “minimum”, a threshold is selected such that the frequency of RC processing constitutes the minimum within an allowable range, in a case where the RC acceleration type 702 is “maximum”, a threshold is selected such that the frequency of RC processing constitutes the maximum within the allowable range, and in a case where the RC acceleration type 702 is “moderate”, a threshold may be selected such that the frequency of RC processing constitutes a moderate value (for example, between the maximum value and the minimum value) within the allowable range. Specifically, for example, in a case where the performance priority mode is selected, since the RC acceleration type is “TOPS”, when the RC acceleration type 702 is “maximum”, the minimum value within the allowable range of the TOPS is configured as the TOPS threshold. In accordance with this, since RC processing is performed even when the TOPS is low, RC processing is carried out frequently. Similarly, in a case where the balance priority mode is selected, since the RC acceleration type is “TOPS”, when the RC acceleration type 702 is “maximum”, the minimum value within the allowable range of the TOPS is configured as the TOPS threshold. However, the minimum value of the TOPS allowable range in the performance priority mode is higher than the minimum value of the TOPS allowable range in the balance priority mode. This is because IO performance is prioritized in the performance priority mode, and as such, it is preferable that the frequency of RC processing be reduced more than in the balance priority mode. Thus, the size of the threshold used will differ in accordance with the selected mode even when the RC acceleration type 702 is the same.

The function 703 is information denoting the types of threshold to be compared in controlling the start of the RC process. For example, the function 703 includes “time specification”, “specified TOPS” and “save power/stop schedule”.

The date 704 is information, which becomes valid when the function 703 is “time specification”. When a current time exceeds a time specified in the date 704, an RC process is started (that is, the frequency of RC processing is high) even when the number of free block is equal to or larger than the above-described number of RC lower-limit blocks. In addition, the time (date) is represented using year, month, day, hour, minute and second, but this time (date) may lack a portion thereof.

The TOPS 705 is information, which becomes valid when the function 703 is “specified TOPS”. For example, in a case where the TOPS exceeds a threshold specified as the TOPS 705, an RC process is started even when the number of free blocks is equal to or larger than the above-described number of RC lower-limit blocks.

The cutoff date 706 is information, which becomes valid when the function 703 is “time specification”. In a case where a current time exceeds a time specified in the cutoff date 706, the RC accelerations is ended even when the number of free blocks is less than the above-described number of RC upper-limit blocks.

Although not shown in FIG. 7, a power consumption threshold may also be included in the table 205.

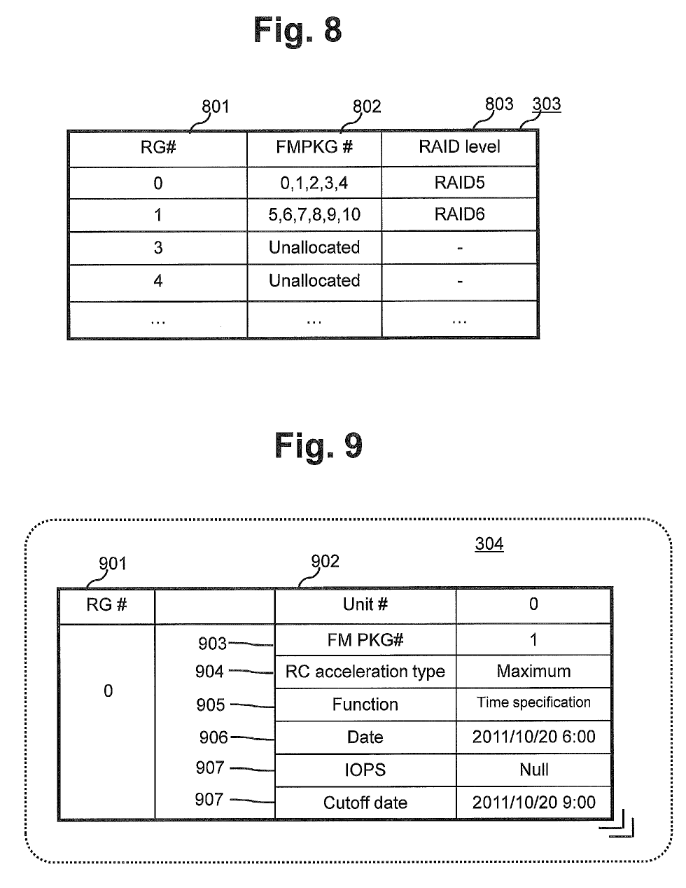

FIG. 8 shows an example of the RG management table 303.

The RG management table 303 associatively stores a RG #801, a FMPKG #802, and a RAID level 803 for each RG.

The RG #801 is information for identifying a RG.

The FMPKG #802 is information for identifying a FM package 40F comprising the RG.

The RAID level 803 is information denoting the RAID level of the RG.

FIG. 9 shows an example of the schedule management table 304.

The schedule management table 304 associatively stores a RG #901, a Unit #902, a PKG #903, a RC type 904, a function 905, a date 906, an TOPS 907, and a cutoff date 908 for each RG.

The RG #901 is information for identifying a RG.

The Unit #902 is information for identifying a unit. The unit is a set of multiple (for example, 12) FM packages 40F.

The FM PKG #903 is information for identifying a flash package comprising the RG.

The RC acceleration type 904, the function 905, the date 906, the IOPS 907, and the cutoff date 908 are the same as the components of the schedule management table 205 shown in FIG. 7, and as such, explanations will be omitted.

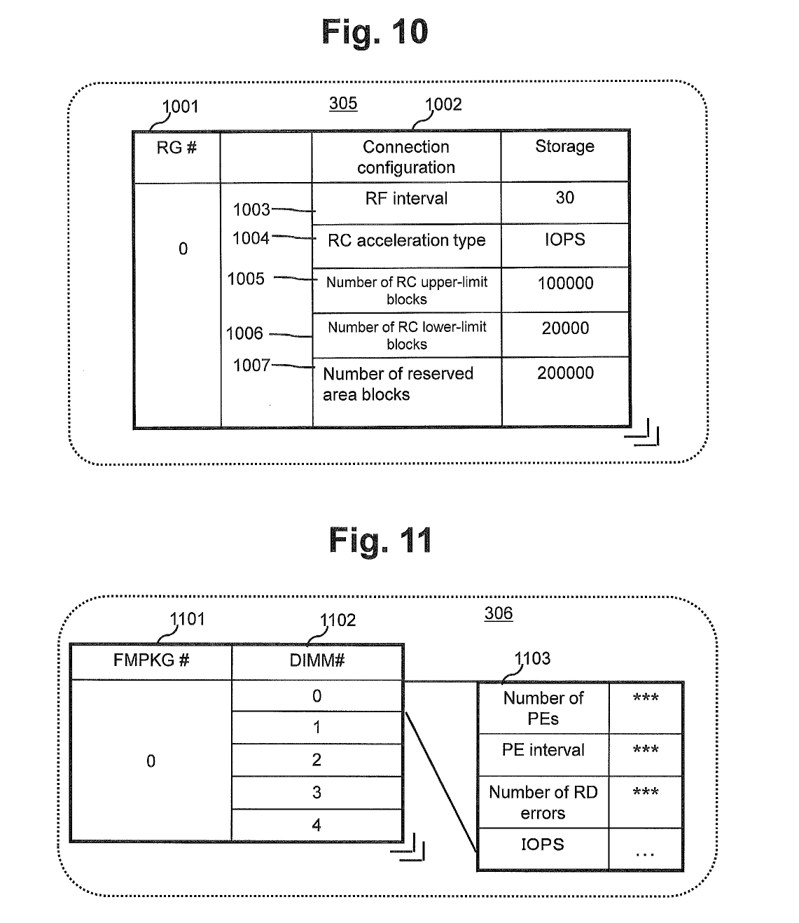

FIG. 10 shows an example of the storage configuration information table 305.

The storage configuration information table 305 correspondingly stores, for each RG, a RG #1001, a connection configuration 1002, a RF interval 1003, a RC acceleration type 1004, the number of RC upper-limit blocks 1005, the number of RC lower-limit blocks 1006, and the number of reserved area blocks 1007.

Of these, the RG #1001, the RF interval 1003, the RC acceleration type 1004, the number of RC upper-limit blocks 1005, and the number of RC lower-limit blocks 1006 are information signifying substantially the same elements as the information elements of the same name of the mode management table 203, and as such, explanations will be omitted.

The connection configuration 1002 is information denoting the type of device controller coupled to the RG. For example, the device controller (in this example, the storage controller 30) coupled to the RG can notify the type of this device to each FM package 40F comprising this RG, and the FM controller 45 (the storage control program 301) can register information denoting this type in the table 305 as the connection configuration 1002. The connection configuration “storage” denotes the fact that the type of device controller coupled to the FM package 40F is a storage controller 30. The connection configuration 1002 is “storage” in this example, but the present invention is not limited to this. For example, in the case of Example 2, which will be described further below, the connection configuration 1002 is “host”. This is because the device controller coupled to the RG is the host computer 20.

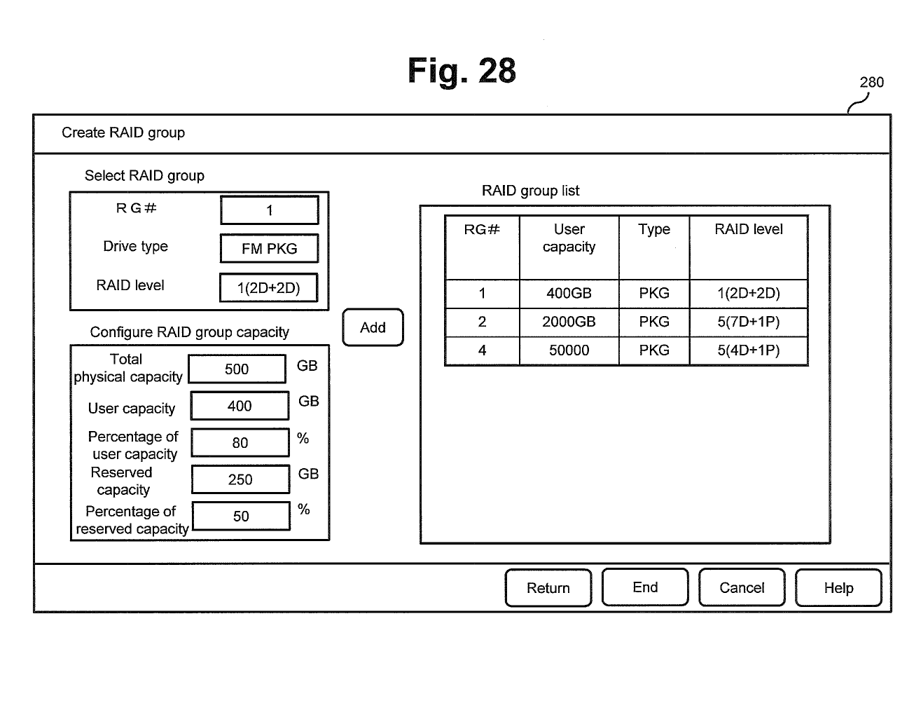

The number of reserved area blocks 1007 is information denoting the number of blocks comprising a reserved area of the RG. In this example, the number of reserved area blocks 1007 can be configured when formatting the RG (refer to RG creation screen 280 of FIG. 28).

FIG. 11 shows an example of the storage statistical information management table 306.

The storage statistical information management table 306 correspondingly stores a FMPKG #1101 and a DIMM #1102 for each FM package 40F. Each FM package 40F comprises multiple DIMMs.

The FMPKG #1101 is information for identifying a FM package 40F.

The DIMM #1102 is information for identifying a DIMM comprising the FM package 40F.

A log item 1103 is associated with each DIMM #1102. In this example, the log items 1103 are the number of PEs, the PE interval, the number of RD errors, and the IOPS, as was explained hereinabove. Since these log items 1103 are the same as the respective multiple log items 603 shown in FIG. 6, explanations of the log items 1103 will be omitted.

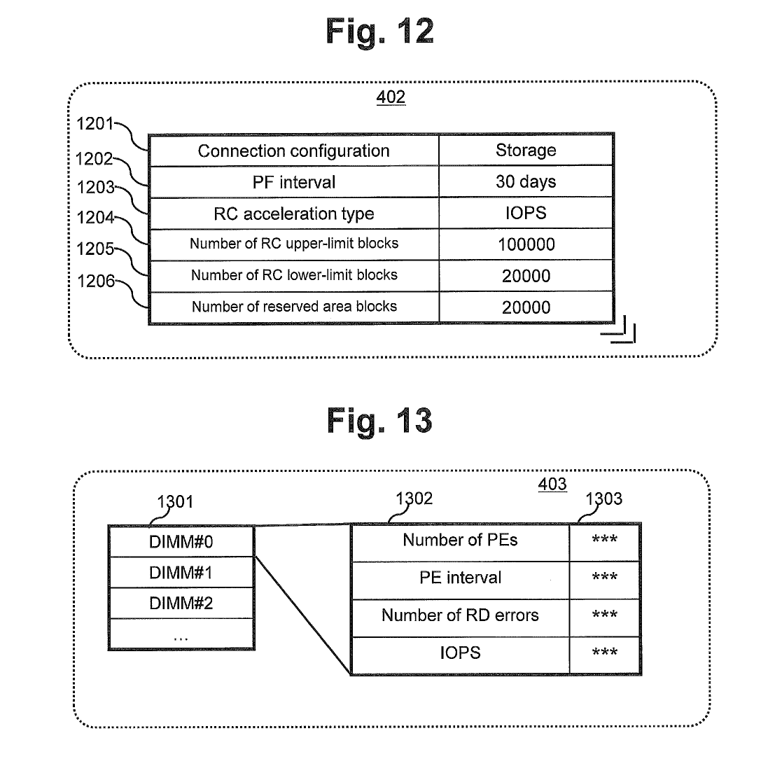

FIG. 12 shows an example of the FM package configuration information management table 402.

The FM package configuration information management table 402 associatively stores a connection configuration 1201, a RF interval 1202, a RC acceleration type 1203, the number of RC upper-limit blocks 1204, the number of RC lower-limit blocks 1205, and the number of reserved area blocks 1206 for each FM package 40F. The values listed in the table 305, which correspond to the RG comprising the FM package 40F corresponding to this table 402, may be reflected in the FM package configuration information management table 402. The information 1201 through 1206 of this table 402 is substantially the same information as the respective information 1002 through 1007 explained using FIG. 10, and as such, explanations of information 1201 through 1206 will be omitted. The number of reserved area blocks 1206 denotes the number of blocks comprising a reserved area of the FM package 40F.

FIG. 13 shows an example of the FM package statistical information management table 403.

The FM package statistical information management table 403 correspondingly manages a DIMM #1301 and one or more log items 1302 for each DIMM.

The DIMM #1301 is information for identifying a DIMM.

The log items 1302 are substantially the same as the log items 603 shown in FIG. 6, and as such explanations of the log items 1302 will be omitted.

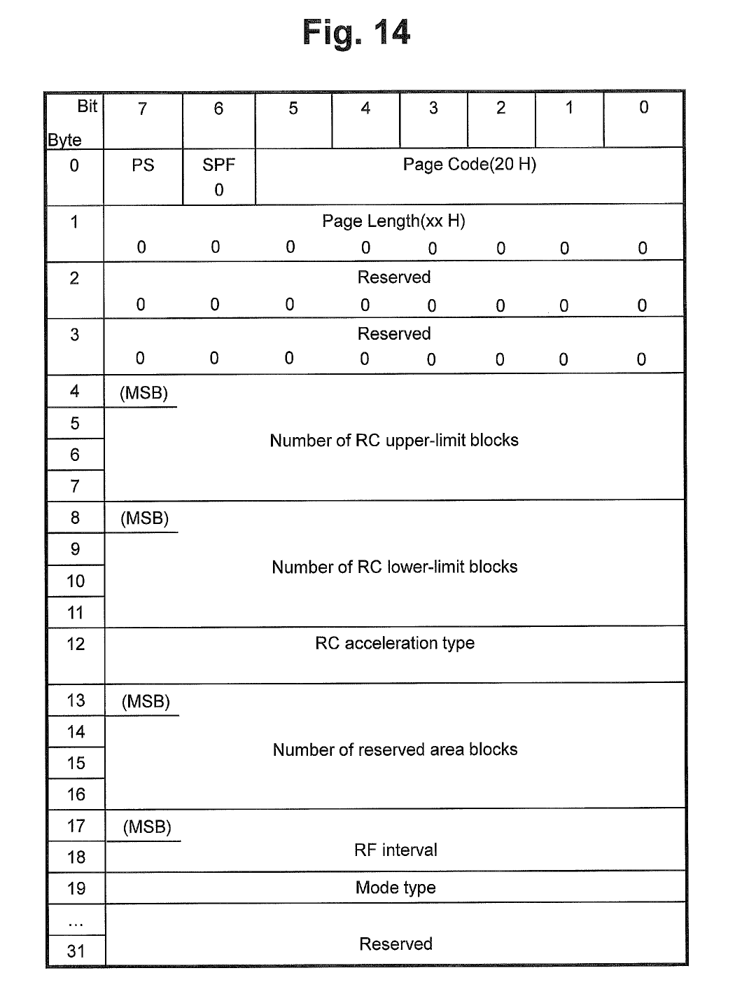

FIG. 14 shows an example of a SCSI MODE SELECT.

The SCSI MODE SELECT is an example of a command, which is sent to the FM package 40F from the device controller (the storage controller 30 in this example), and is an example of a command, which is used as a setting/reference command for configuring information in the FM package configuration information management table 402, and referencing the information in this table 402. The horizontal axis represents a Bit, and the vertical axis represents a Byte. The setting/reference command is not limited to the SCSI MODE SELECT, and another protocol or command may be used. In addition, the “mode type” shown in the drawing may be a value denoting whether the mode is any of the performance priority mode, the balance priority mode, or the life priority mode. Instead of the “number of reserved area blocks” shown in the drawing, an element capable of being used in the computation of the number of reserved area blocks, for example, a reserved capacity (the capacity of the reserved area) and/or the ratio of the RG capacity and the reserved capacity (the percentage of the reserved capacity with respect to the capacity of the RG), may be used (refer to FIG. 28).

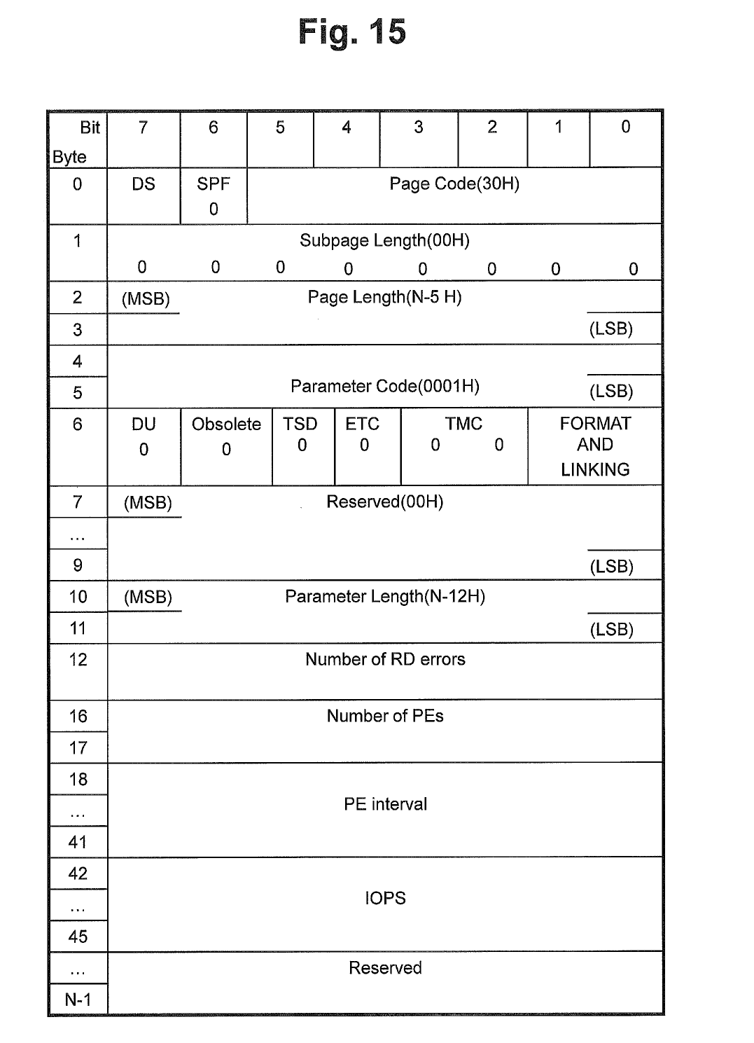

FIG. 15 shows an example of a LOG SENSE.

The LOG SENSE is an example of a command, which is sent to the FM package 40F from the storage controller 30, and is an example of a command, which is used to acquire log information. The horizontal axis represents the Bit, and the vertical axis represents the Byte. The command for acquiring log information is not limited to the LOG SENSE, and another protocol or command may be used. According to the LOG SENSE of FIG. 15, the types of logs to be included in the log information (number of RD errors, number of PEs, PE interval, and IOPS) are listed. The FM controller 45, upon receiving the LOG SENSE, sends log information comprising a log of the type, which conforms to the LOG SENSE, to the storage controller 30 included in a response to the LOG SENSE.

In this example, a parameter group or a log can be configured in a prescribed field (for example, a free field) in an existing command as has been explained by referring to FIGS. 14 and 15.

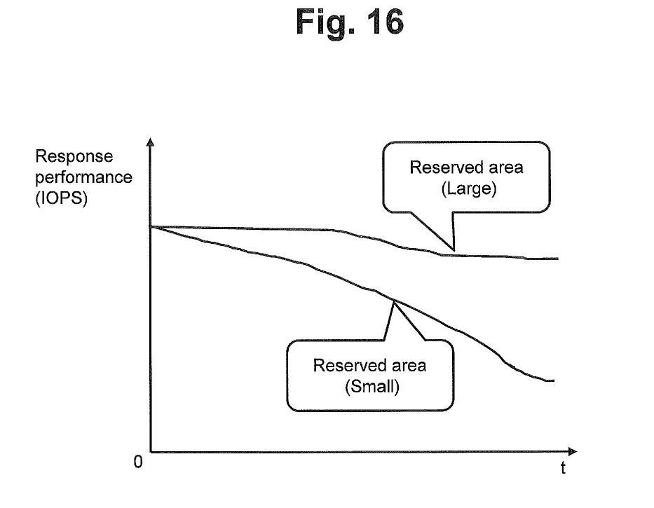

FIG. 16 shows an example of the relationship between the size of a reserved area of a FM package 40F and the degree of deterioration of the response performance of the FM package 40F.

The horizontal axis denotes the time, and the vertical axis denotes the response performance (for example, IOPS (or a response time)). As shown in the drawing, the more reserved areas the FM package 40F secures, the less response performance is subject to deterioration. That is, since a large number of reserved areas results in the securing of a larger buffer area, response performance becomes less subject to deterioration. As was mentioned above, the capacity of the reserved area can be configured when the FM package 40F (or the RG) is formatted.

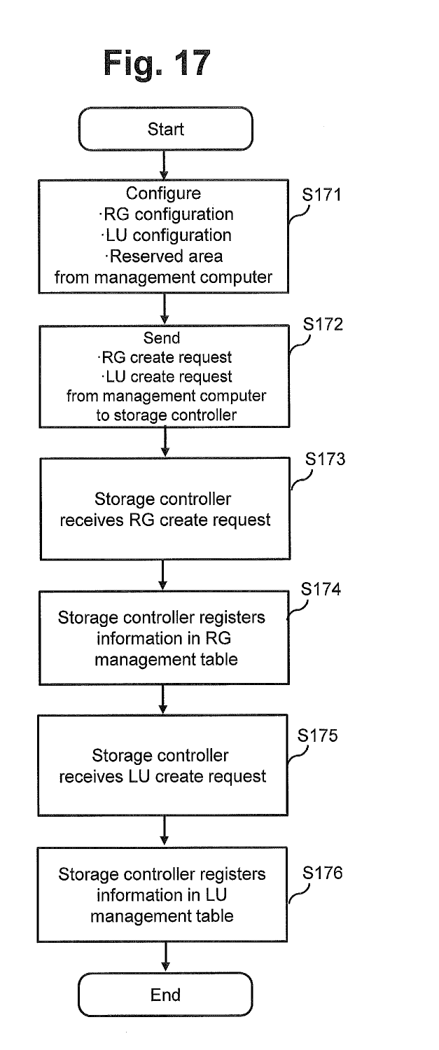

FIG. 17 shows an example of the flow of an LU and RG creation process.

The management computer 10 receives an input of information from the user via the GUI 14 respectively denoting an RG configuration (RG #801, FMPKG 802, and RAID level 803), an LU configuration, and a reserved area capacity (refer to FIG. 28), and configures the inputted information (information respectively denoting the RG configuration, the LU configuration, and the reserved area capacity) in tables 303 and 307 (S171).

The management computer 10 sends an RG creation request and a LU creation request to the storage controller 30 (S172). The reserved area capacity (that is, the number of blocks in the reserved area) is included in each of the RG creation request and the LU creation request. The RG creation request is a request, which comprises the RG configuration information (information denoting the RG configuration) configured by the user in S171, and which is sent from the management computer 10 to the storage controller 30, and is a request to create a RG. The LU creation request is a request, which comprises the LU configuration (information denoting the LU configuration) configured by the user in S171, and which is sent from the management computer 10 to the storage controller 30, and is a request to create a LU.

The storage control program 301 receives the RG creation request from the management computer 10 (S173).

The storage control program 301 registers the RG configuration information included in the received RG creation request in the RG management table 303 (S174).

The storage control program 301 receives the LU creation request from the management computer 10 (S175).

The storage control program 301 registers the LU configuration information included in the received LU creation request in the LU management table 307 (S176).

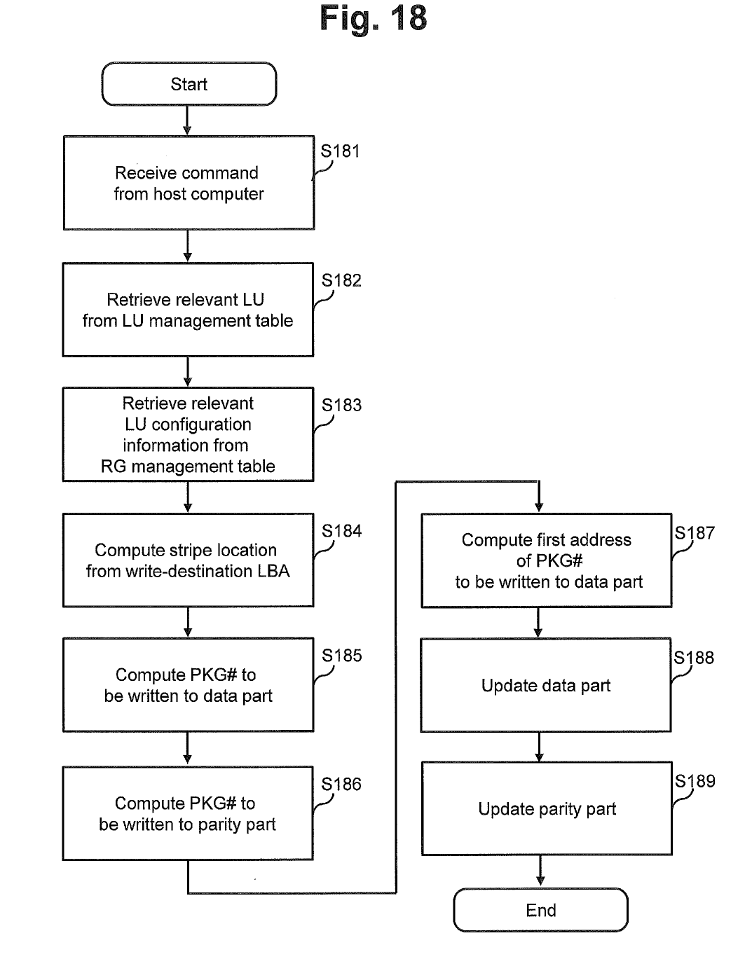

FIG. 18 shows an example of the flow of a write process by the storage controller 30.

The storage control program 301 receives a write command from the host computer 20 (S181).

The storage control program 301 retrieves the LU specified by the write command from the LU management table 307 (S182).

The storage control program 301 retrieves LU configuration information of the LU found in S182 from the RG management table 393 (S183).

The storage control program 301 computes a stripe location based on the LBA (Logical Block Address) specified by the write command (S184).

The storage control program 301 computes a FM package 40F, which will serve as the write destination of a portion of data (hereinafter, the data part) of the data (write-target data) conforming to the write command (S185).

The storage control program 310 also computes a FM package 40F, which will serve as the write destination of parity (hereinafter, the parity part) based on the write-target data (S186). S186 is not performed in a case where an RG having a RAID level for which parity is not necessary is the write target.

The storage control program 301 computes a first address of the FM package 40F computed in S185 (S187).

The storage control program 301 writes the data part to the FM package 40F computed in S185 (S188). That is, the storage control program 301 sends a write command, which treats the data part as the write target, to the FM package 40F computed in S185.

In addition, the storage control program 301 writes the parity part to the FM package 40F computed in S186 (S189). That is, the storage control program 301 sends a write command, which treats the parity part as the write target, to the FM package 40F computed in S186.

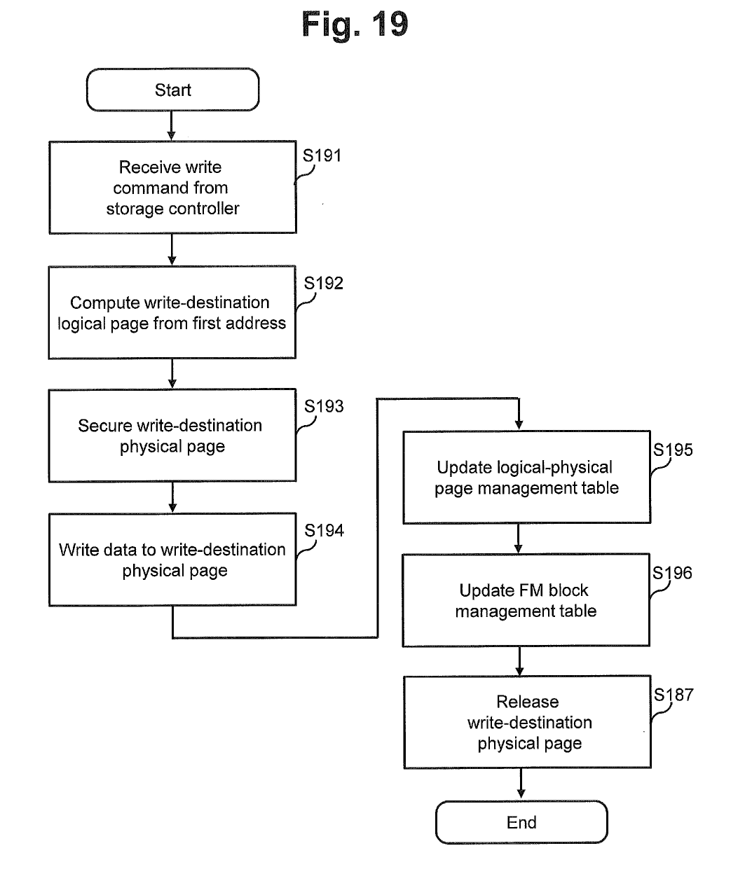

FIG. 19 shows an example of the flow of a write process by the FM controller 45.

The FM package control program 401 receives a write command from the storage controller 30 (S191).

The FM package control program 401 computes a write-destination logical page on the basis of the first address (and data size) specified by the write command (S192).

The FM controller 45 secures a write-destination physical page to which to write the data (either the data part or the parity part) appended to the write command, that is, the physical page, which is allocated to the write-destination logical page (S193).

The FM package control program 401 writes the write-target data to the write-destination physical page secured in S193 (S194).

The FM package control program 401 updates a logical-physical page management table (omitted from the drawing) (S195). The FM package control program 401 updates a FM block management table (omitted from the drawings) (S196). The logical-physical page management table shows the corresponding relationship between an address (logical address) specified by the host computer 20 and a FM address (physical address), specifically, for example, the corresponding relationship between the logical address and the physical address. The FM block management table shows a table for managing information (for example, the free status of a block, the number of PEs of a block, and so forth) of a block comprising FM chips 431.

The FM package control program 401 releases the secured write-destination physical page (S197).

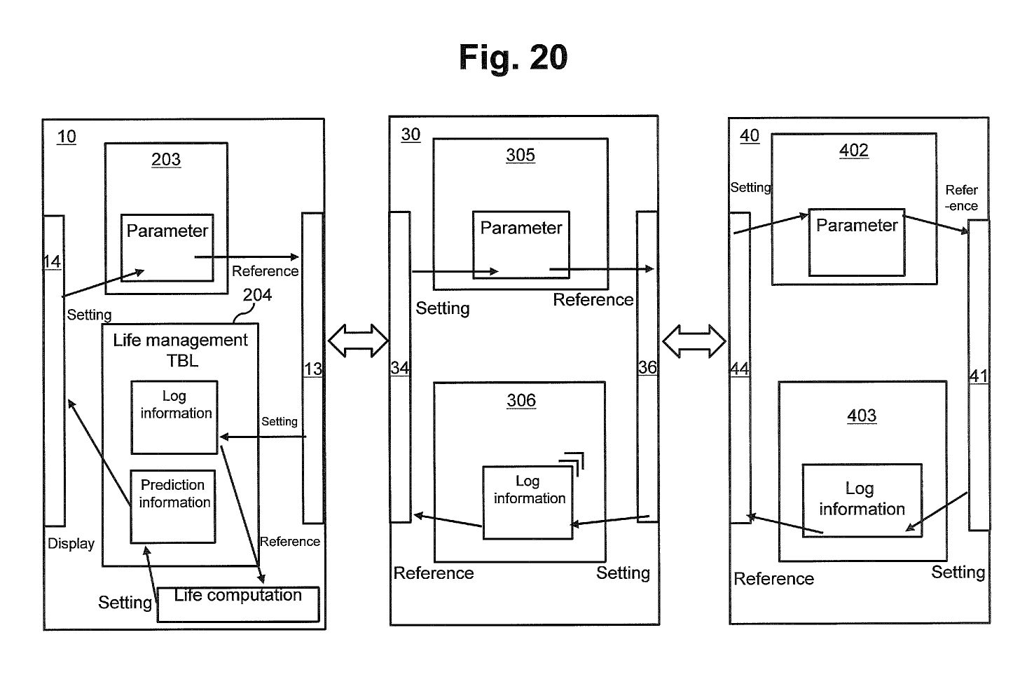

FIG. 20 is a schematic diagram denoting exchanges among apparatuses in this example.

In this example, a parameter, which the user inputs to the management computer 10 with respect to a RG, can be configured in each FM package 40F comprising this RG by way of the storage controller 30. In this example, the management computer 10 can provide the user with information (for example, the life of the RG) conforming to an operation result (log information) of the FM package 40F.

That is, each FM package 40F operates on the basis of a user-inputted parameter, and the management computer 10 displays information conforming to the result of the operation based on this parameter. That is, information conforming to an operation result based on a user-inputted parameter is fed back to the user. The user can change the parameter on the basis of this information.

(A) The flow of processing from the inputting of a parameter into the management computer until this parameter is configured in the FM package 40F, and (B) the flow of processing from the outputting of log information until the display of information conforming to this log information will be respectively explained hereinbelow by referring to the drawings. In the following explanations, table will be abbreviated as TBL.

<(A) Flow of processing from the inputting of a parameter into the management computer until this parameter is configured in the FM package 40F>

(*) The management computer 10 receives an RG-related parameter (a parameter for each item) via the GUI 14. The parameter inputted by the user is registered in the mode management TBL 203.

(*) The management computer 10 sends the parameter registered in the mode management TBL 203 to the storage controller 30. The storage controller 30 receives the parameter, and registers this parameter in the storage configuration information management TBL 305.

(*) The storage controller 30 sends the parameter registered in the storage configuration information management TBL 305 to all the FM packages 40F comprising the RG of this parameter. The FM controller 45 receives the parameter, and registers the received parameter in the FM PKG configuration information management TBL 402.

The preceding is an explanation of the flow of processing of (A). An operation is performed in the FM package 40F on the basis of the parameter registered in the FM PKG configuration information management TBL 402.

<(B) Flow of processing from output of log information until the display of information conforming to this log information>

(*) The FM controller 45 collects the log information of the FM package 40F (in the flow of processing of (A) described hereinabove, the information denoting the result of the operation based on the parameter registered in the FM PKG configuration information management TBL 402), for example, in units of DIMMs. The collected log information is registered in the FM PKG statistical information management TBL 403.

(*) The FM controller 45 sends the log information registered in the FM PKG statistical information management TBL 403 to the storage controller 30. The storage controller 30 receives the log information, and registers the received log information in the storage statistical information management TBL 306 in units of FM packages 40F. (*) The storage controller 30 sends the log information registered in the storage statistical information management TBL 306 to the management computer 10. The management computer 10 receives the log information, and registers this log information in the life management TBL 204 in units of RGs. The management computer 10 computes information based on the log information, and displays the computed information. For example, the life computation program 202 computes the life with respect to each RG based on the RG-unit log information. The life computation program 202 stores the computed life.

The preceding is an explanation of the flow of processing of (B). The life computation program 202 may display the computed life each time the flow of processing of (B) is performed. Or, subsequent to the flow of processing of (B) having been performed multiple times, the life computation program 202 may compute the life based on the RG-unit log information (that is, based on the transition of the numeric values serving as a log) acquired each time. As was explained hereinabove, the user can decide a parameter to be configured in a RG on the basis of feedback (for example, the remaining life of the RG) with respect to the RG, and change the parameter configured in the RG to this decided parameter. The above-described (A) is started once again in accordance with this. Actually, for example, after performing the parameter input (the above-described (A)), a future trend is predicted in accordance with the log information being acquired multiple times (the flow of processing of the above-described (B) is performed multiple times), and parameter revision (the above-described (A)) could be performed on the basis of this prediction.

Specific examples of a series of flows of processing regarding the inputting of a parameter group (one or more parameters respectively corresponding to one or more items), the outputting of result information based on log information denoting the result of an operation in accordance with this inputted parameter group, and the changing of at least one parameter on the basis of this result information and inputting of this post-change parameter, will be described.

### Specific Example 1

(a1) In the (B) explained hereinabove, it is preferable that either the PE interval included in the log information or the PE interval (hereinafter, the log PE interval) obtained on the basis of this PE interval be long for each FM package 40F. However, when the log PE interval for the FM package 40F is long, the frequency of erase processing is low, and as such, the total number of erases for this FM package 40F (in other words, the number of free blocks in this FM package 40F) is small. The total number of erases of the FM package 40F is identifiable from the number of PEs included in the log information or the number of PEs (hereinafter, the number of log PEs) obtained on the basis of this number of PEs. A log as a numeric value identified from the log information (may be called the log value hereinbelow), such as the log PE interval and the number of log PEs, may either be in units of individual blocks or units of a group of blocks. Units of a group of blocks, for example, may be units of chips, units of DIMMs, or units of FM packages. In the case of units of a group of blocks, the group of blocks unit may be the total of multiple log values respectively corresponding to the multiple blocks comprising the group of blocks. The log value of units of individual blocks may be a value based on multiple log values respectively corresponding to multiple blocks (for example, a maximum value, a minimum value, or an average value), or may be the log value of a typical block.

(b1) The amount of change of the number of log PEs with respect to the amount of change of a log PE interval denotes the size of the RC acceleration. That is, when the RC acceleration is large, the frequency of erase processing is high, and as such, the amount of change of the number of log PEs will increase with respect to a constant amount of change of the log PE interval. The user (the user of the management computer 10 in Example 1), based on the amount of change of the number of log PEs and the amount of change of the log PE interval, can decide what the value of the RC acceleration type should be (for example, whether to use one of maximum, minimum, or moderate) and what the mode should be (for example, whether to select one of the performance priority mode, the balance priority mode, or the life priority mode), and can change the inputted (configured) RC acceleration type and/or the mode type in accordance with this decision. The size of the RC acceleration may be computed using another method decided on the basis of the amount of change of the log PE interval and the amount of change of the number of log PEs.

(c1) The life computation program 202 in the management computer 10 can compute the time it takes for the number of log PEs to reach the upper limit of the number of PEs as the remaining life based on (p) the upper limit of the number of PEs of the FM package 40F (the upper limit of the number of erases), (q) the transition of the number of log PEs of this FM package 40F (for example, the cumulative value of the number of log PEs), and (r) the amount of change of the number of log PEs of this FM package 40F. The upper limit of the number of PEs of the FM package 40F may be the total of the upper limit of the number of erases of multiple blocks of this FM package 40F. In a case where the remaining life is short, the user may change the RC acceleration type to a smaller value (for example, change the RC acceleration type from “maximum” to “moderate” or “minimum”) and may change the mode type to a mode that gives more priority to life (for example, change the mode type from “performance priority mode” to “balance priority mode” or “life priority mode”). The method for predicting the remaining life is not limited to the above. For example, the remaining life may be predicted on the basis of the transition of a log TOPS (either the TOPS included in the log information or a value based on this TOPS) and/or the number of log RD errors (either the number of RD errors included in the log information or a value based on this number of RD errors) either instead of or in addition to at least one of the elements of the above-mentioned (p) through (r).

### Specific Example 2

(a2)) In a case where the remaining life computed in accordance with a method such as the above-described (e1) is shorter than the user-desired period of time, the user can shorten the RF interval. This is because the period during which data can be retained (the elapsed time from the writing of data to a free block) tends to become worse when the remaining life is short. That is, making a selection, which increases the frequency of the RF process, is done in order to continue to retain data without loss even when the remaining life is short.

### Specific Example 3

(a3)) In a case where the remaining life computed in accordance with a method such as the above-described (e1) is shorter than the user-desired period of time, the user can increase the number of RC lower-limit blocks and/or decrease the number of RC upper-limit blocks. This makes it possible to slow down the trigger for starting a RC process and/or to speed up the trigger for ending a RC process. That is, the speed at which the number of PEs increases can be reduced for the FM package 40F as a whole.

Thus, the user, after having inputted a parameter group (one or more parameters), which influences the operation of the FM package 40F, can decide which parameter of the configured parameter group should be changed to what value based on the transition of a value conforming to log information at multiple points in time acquired either regularly or irregularly as information denoting an operation result conforming to this inputted parameter group (the transition of the log information of multiple points in time or of the remaining life predicted on the basis thereof).

Therefore, for example, even when the required specifications of the FM package change, it should be possible to deal flexibly with this specification change without allocating additional funds for installation costs or revising the number of FM packages.

In addition, by looking at the number of log PEs and the number of log RD errors, the user should be able to figure out that the number of RD errors is increasing by the increase in old blocks (blocks for which the difference between the number of erases and the upper limit therefor has become less than a fixed value). The destruction of such an FM module will probably be taken under consideration in this case, but when the utilization period of this FM module has not reached the FM module end-of-life, it will probably become necessary to budget for additional amortization costs. However, according to this example, the user can identify a situation such as that described above from information based on the log information acquired from the FM module 40F, and in such a case, the user can continue to store data in this FM module while maintaining reliability by changing the mode type and changing the RF interval. Thus, it is possible to continue using this FM module 40F longer while maintaining the reliability of the FM module 40F, thereby hopefully avoiding the problem of budgeting for additional amortization costs.

According to this example, multiple modes are available for the FM module 40F, and it is possible to select the mode type as the parameter. For this reason, from the standpoint that it is probably normal to also change the mode type in a case where the application of the FM module 40F changes part way through its use, in addition to the tendency for the remaining life to decrease up to this point, the management computer can present the user with the optimum replacement time for the FM module 40F by making allowances for the post-change mode type. A value of another type of parameter (that is, the RF interval, the RC acceleration type, the number of RC upper-limit blocks, and the number of RC lower-limit blocks) for each mode (that is, for each of the performance priority mode, the balance priority mode, and the life priority mode) may be determined by default. The user may be able to change this default value.

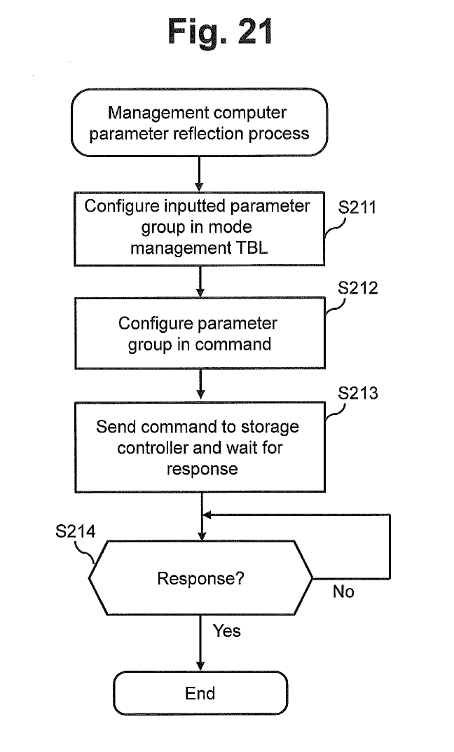

Next, the flow of processing for configuring a parameter in the FM package 40F will be explained by referring to FIGS. 21 through 23. According to this processing, a parameter group, which the user inputs to the management computer 20, is configured in each FM package 40F comprising the RG from the management computer 20 by way of the storage controller 30. This processing corresponds to the processing of (A) described hereinabove.

FIG. 21 shows an example of the flow of a parameter reflection process.

The GUI management program 201 registers a parameter group configured by the user via the GUI 14 of the management computer 20 in the mode management TBL 203 (S211). The parameter group need not comprise all of the parameters mentioned hereinabove, and at the least may comprises one parameter. The parameter group may comprise the number of reserved area blocks.

The GUI management program 201 configures the parameter group registered in the mode management TBL and the RG #corresponding to this parameter group in a command (for example, the SCSI MODE SELECT) (S212).

The GUI management program 201 sends the command comprising the parameter group configured in S212 (hereinafter, the first parameter setting command) to the storage controller 30 (S213). The GUI management program 201 waits for a response from the storage controller 30 with respect to the sent first parameter setting command (S213).

In a case where there is a response from the storage controller 30 (S214: Yes), the GUI management program 201 ends the processing.

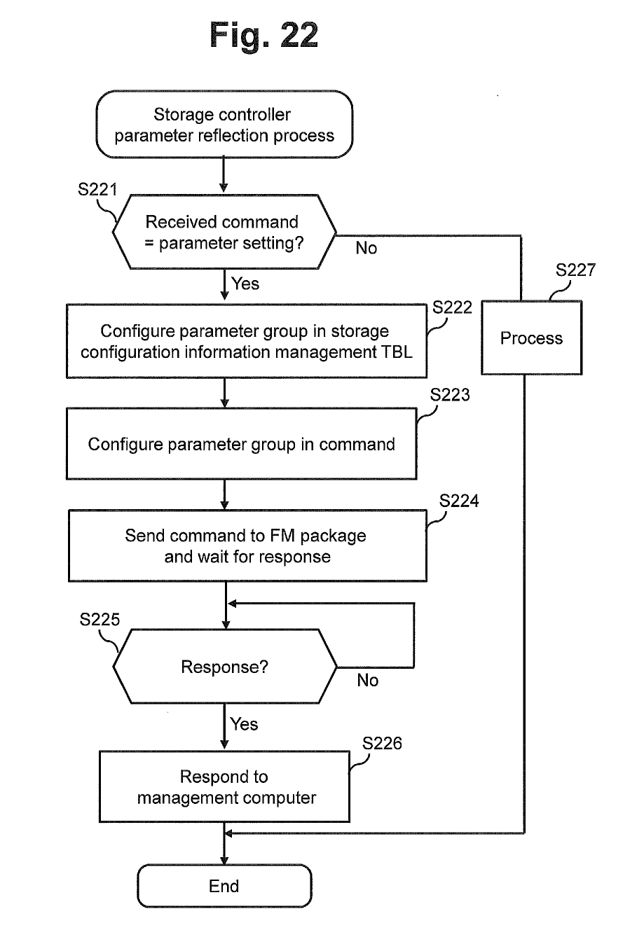

FIG. 22 shows an example of the flow of a parameter reflection process by the storage controller 30.

The storage control program 301, upon receiving a command from the management computer 10, checks whether or not this command is the first parameter setting command (S221).

In a case where the received command is not the parameter setting command (S221: No), the storage control program 301 performs the processing of this command (for example, I/O processing in a case where the command is an I/O command) (S227).

In a case where the received command is the parameter setting command (S221: Yes), the storage control program 301 configures the parameter group inside the parameter setting command in a area, which corresponds to the RG #corresponding to this parameter group in the storage configuration information management TBL 305 (S222).

The storage control program 301 configures the parameter group configured in the TBL 305 in a command, which is sent to the FM package 40F (S223).

The storage control program 301 sends the command comprising the parameter group configured in the TBL 305 (hereinafter, the second parameter setting command) to each FM module 40F comprising the RG corresponding to this parameter group, and waits for a response from the destination FM package 40F with respect to the second parameter setting command (S224).

In a case where there are responses from all of the destination FM packages 40F (S225: Yes), the storage control program 301 sends a response to the management computer 10 with respect to the first parameter setting command received from the management computer 10 (S226).

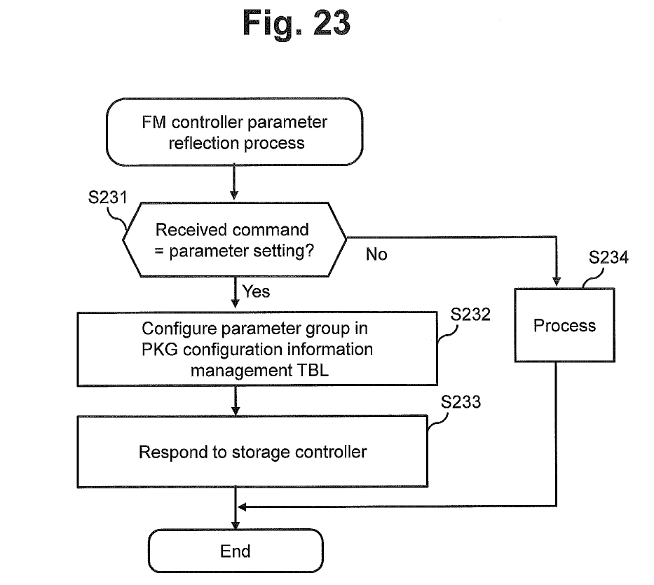

FIG. 23 shows an example of the flow of a parameter reflection process by the FM package 40F.

The FM package control program 401 checks whether a command received from the storage controller 30 is the second parameter setting command (S231).

In a case where the received command is not the second parameter setting command (S231: No), the FM package control program 401 performs the processing of this command (for example, I/O processing in a case where this command is an I/O command) (S234).

In a case where the received command is the second parameter setting command (S231: Yes), the FM package control program 401 registers the parameter group inside the second parameter setting command in the FM package configuration information management TBL 402 (S232).

The FM package 40F sends a response to the storage controller 30 with respect to the second parameter setting command (S233).

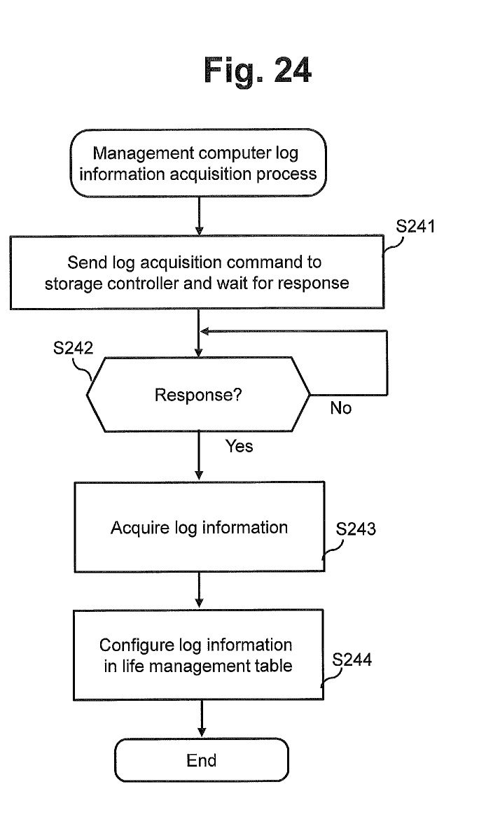

Next, the flows of processing via which the FM package 40F acquires log information will be explained by referring to FIGS. 24 through 26. According to this processing, the management computer 10 can acquire the log information of the FM package 40F comprising the RG from the FM package 40F by way of the storage controller 30. This processing corresponds to the processing of (B) described hereinabove.

FIG. 24 shows an example of the flow of a log information acquisition process by the management computer 10.

The GUI management program 201 sends a command (for example, a LOG SENSE) for acquiring log information (for example, information comprising the number of PEs, the PE interval, the number of RD errors, and the IOPS) to the storage controller 30, and waits for a response from the storage controller 30 with respect to the sent command (hereinafter, the first log acquisition command) (S241). The first log acquisition command may comprise the RG #. This makes it possible to acquire log information regarding the RG of this RG #.

The GUI management program 201, in a case where a response with respect to the first log acquisition command has been received from the storage controller 30 (S242: Yes), acquires the log information included in the response (S243).

The GUI management program 201 registers the acquired log information, for example, in an area, which corresponds to the RG corresponding to this log information in the life management TBL 204 (S244).

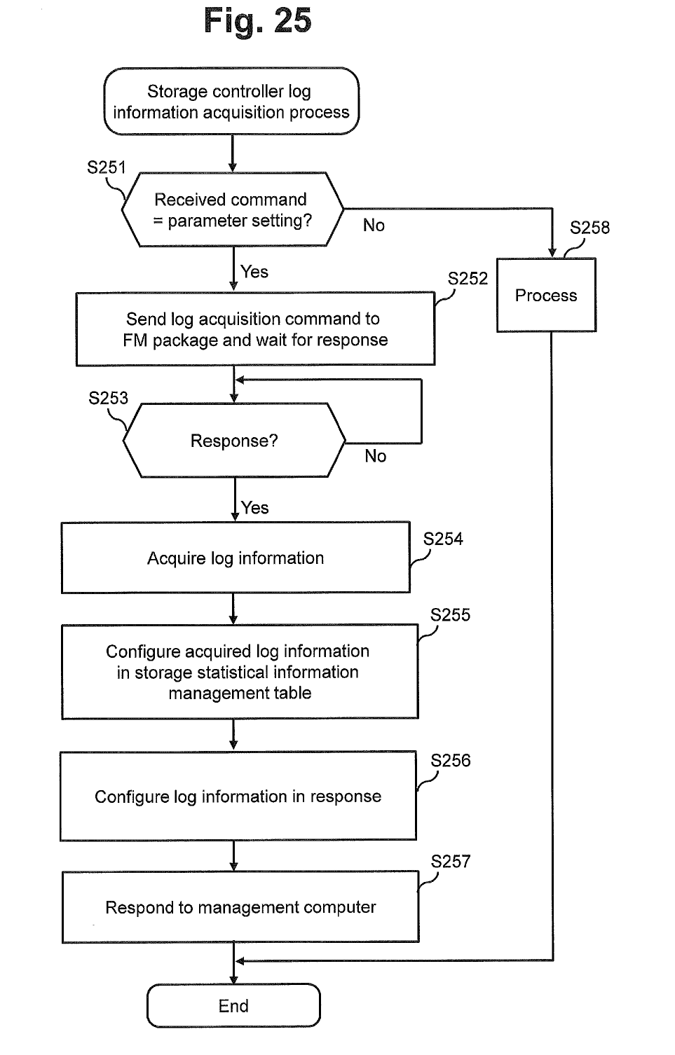

FIG. 25 shows an example of the flow of a log information acquisition process by the storage controller 30.

The storage control program 301 receives a command from the management computer 10, and checks whether or not the received command is a first log acquisition command (S251).

In a case where the received command is not the first log acquisition command (S251: No), the storage control program 301 performs the processing of this command (for example, I/O processing in a case where this command is an I/O command) (S258).

In a case where the received command is the first log acquisition command (S251: Yes), the storage control program 301 sends a command (hereinafter, the second log acquisition command) for acquiring log information with respect to the FM package 40F to each FM package 40F comprising the log acquisition-target RG (for example, the RG corresponding to the RG #specified in the first log acquisition command), and waits for a response with respect to the sent second log acquisition command (S252).

In a case where there are responses to the second log acquisition command from all the destination FM packages 40F (S253: Yes), the storage control program 301 acquires the log information included in the responses (S254).

The storage control program 301 configures the acquired log information in the storage statistical information management TBL 306 in units of RGs (S255).

The storage control program 301 configures the configured log information in a response with respect to the first log acquisition command (S256). For example, the storage control program 301 may configure all of the log information acquired from multiple FM packages 40F comprising the RG in the response with respect to the first log acquisition command, and may compute an average value for various types of logs and configure the average value of the various types of logs in the relevant response.

The storage control program 301 sends a response (a response with respect to the first log acquisition command), which includes the log information, to the management computer 10 (S257).

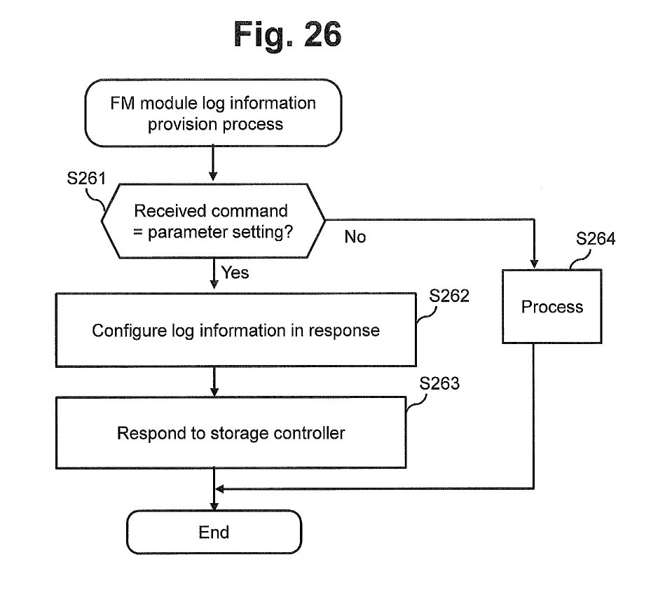

FIG. 26 shows an example of the flow of a log information provision process by the FM package 40F.

The FM package control program 401 receives a command from the storage controller 30, and checks whether or not the received command is a second log acquisition command (S261).

In a case where the received command is not the second log acquisition command (S261: No), the FM package control program 401 performs the processing of this command (for example, I/O processing in a case where this command is an I/O command) (S264).

In a case where the received command is the second log acquisition command (S261: Yes), the FM package control program 401 configures log information, which comprises multiple logs configured in the FM package statistical information management TBL 403, in a response with respect to the second log acquisition command (S262). That is, the FM package control program 401

The FM package control program 401 sends the response with respect to the second log acquisition command to the storage controller 30 to the storage controller 30 (S263).

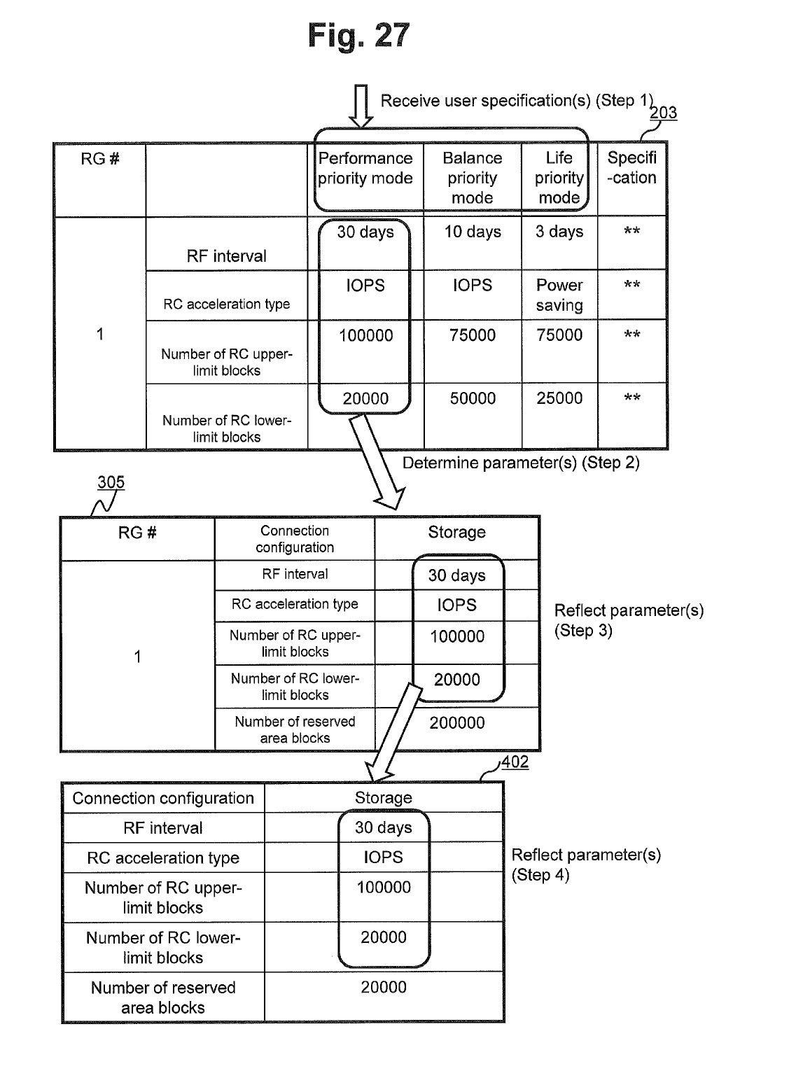

FIG. 27 shows an example of the flow of a parameter group.

According to FIG. 27, the parameter group configured in the FM package 40F is only for one mode. In a case where a mode has been selected by the user via the GUI 14 for a certain RG (hereinafter, the “target RG” in the explanation of FIG. 27), the parameter group for this mode is configured in each FM package comprising the target RG.

In a case where the mode for the target RG has changed, the parameter group configured in each FM package 40F comprising the target RG is updated to the parameter group corresponding to the post-change mode.

A specific example will be explained below by referring to FIG. 27.

In this example, as was explained hereinabove, the modes include the “performance priority mode”, the “balance priority mode” and the “life priority mode”. It is supposed here that the user has selected the “performance priority mode” from among the “performance priority mode”, the “balance priority mode” and the “life priority mode”.

The user inputs to the GUI 14 of the management computer 10 the “performance priority mode” selection and a parameter group (multiple parameters respectively corresponding to multiple items, such as RF interval and RC acceleration type) for the “performance priority mode” with respect to the target RG (Step 1). In a case where a default parameter group is associated with the “performance priority mode” and the parameter group may be this default parameter group, the parameter group input by the user may be omitted.

The target RG parameter group is registered in the mode management TBL 203 related to the selected mode (Step 2). In the example of the drawing, using an “Item: parameter” format, “RF interval: 30 days”, “RC acceleration type: TOPS”, “number of RC upper-limit blocks: 100000”, and “number of RC lower-limit blocks: 20000” are registered in the mode management TBL 203 as the parameter group corresponding to the performance priority mode of the target RG.

The parameter group registered in the mode management TBL 203 is registered in the storage configuration information TBL 305 of the storage controller 30 with respect to the target RG (Step 3).

Then, the parameter group registered in the storage configuration information TBL 305 is reflected in the FM package configuration information management TBL 402 of each FM package 40F comprising the target RG (Step 4).

FIG. 28 shows an example of a RG creation screen 280.

The RG creation screen 280 is a first example of the GUI 14, and comprises a RG selection area 281, a RG capacity setting area 282, and a RG list area 283. The RG creation screen 280, for example, is located at a prescribed layer of the GUI 14 of the management computer 10. The RG creation screen 280 is displayed in the GUI 14 in accordance with the GUI management program 201 of the management computer 10.

According to FIG. 28, the RG creation screen 280 receives from the user in relation to the RG the input of a parameter, which is substantially equivalent to the number of reserved area blocks, that is, the reserved capacity (the capacity of the reserved areas) and/or the reserved capacity ratio (the percentage of the reserved capacity with respect to the capacity of the RG).

The inputted reserved capacity and/or reserved capacity ratio constitute one of the parameters included in the parameter group influencing the operation of the FM package 40F. The storage controller 30 or the FM controller 45 can compute the number of reserved areas based on the reserved capacity in the parameter group (or a capacity computed on the basis of the reserved capacity ratio and the RG capacity in the parameter group) and the size of a single block, and can register the number of reserved area blocks in the TBLs 305 and 402.

The FM controller 45 can provide a logical space (for example, an aggregate of logical blocks) for the user capacity inputted by the user in FIG. 28 to the storage controller 30. In a case where blocks (physical blocks) have been allocated to all the logical spaces, the number of blocks not allocated to the logical space is equal to or larger than the number of reserved area blocks.

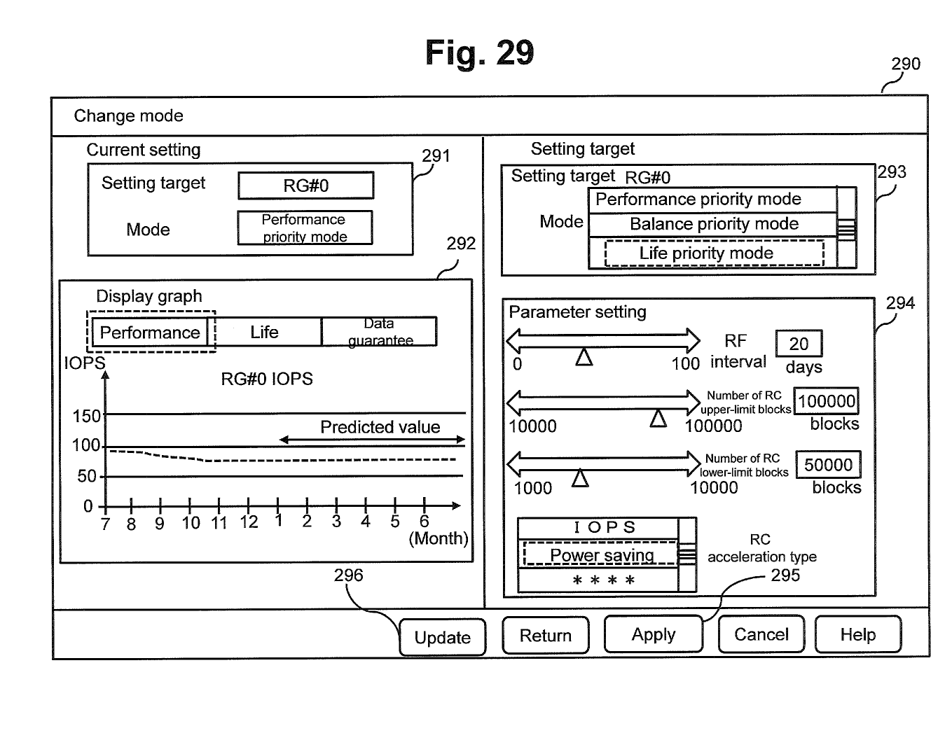

FIG. 29 shows an example of a mode change screen 290.

The mode change screen 290 is a second example of the GUI 14, and comprises a current setting area 291, a graph display area 292, a change setting area 293, and a parameter setting area 294. The user can use the mode change screen 290 to change the mode and change the parameter corresponding to the current or post-change mode with respect to the RG (the “target RG” in the explanation of FIG. 29).

An RG ID, which is regarded as the target RG, can be inputted into the current setting area 291, and the current mode selected for the RG of the inputted RG ID is displayed.

A graph related to the “performance”, “life” and “data guarantee” of the target RG is displayed in the graph display area 292. When any of the “performance”, the “life”, and the “data guarantee” is selected by the user, a graph related to the “performance”, the “life”, and the “data guarantee” of the target RG is displayed on the basis of the latest log information (refer to the life management TBL 204).

The graph referred to here shows the transition of numeric values from the past to the present in accordance with the log information of the target RG, and the transition of future numeric values predicted on the basis of the log information. In the example shown in the drawing, it is currently January, and as such, a graph from July through January shows the transition of log values (for example, the target RG IOPS) from the past to the present, and the transition of log values from January through June denotes the transition of log values predicted for the future. The GUI management program 201 can express the transition of log values from the past to the present in accordance with storing all acquired log information (or by collecting log information for each prescribed time period (for example, for each month) and computing an average value for each prescribed time period). The GUI management program 201 can also compute the transition of predicted log values from the present to the future based on the transition of the log values from the past to the present (and the transition of another log value (or the remaining life obtained based on the log values)).

In the change setting area 293, the mode (the current mode) configured with respect to the target RG (for example, the RG selected as the setting target in the current setting area 291) can be changed. That is, this area 293 receives a post-change mode selection with respect to the target RG.

An input field for each parameter of the post-change mode selected in the area 293 is displayed in the parameter setting area 294. In the example shown in the drawing, the user can input a desired parameter for each of multiple items (RF interval, number of RC upper-limit blocks, number of RC lower-limit blocks, and RC acceleration type) related to the post-change mode “life priority mode”. An upper limit and lower limit of a selectable parameter may be decided for each item. The upper limit and lower limit of a parameter may differ in accordance with the mode for each item.

When an apply button 295 is pressed, the GUI management program 201 registers the parameter group in the screen 290 at the point in time at which the apply button 295 was pressed in the mode management TBL 203 with respect to the target RG.

When an update button 296 is pressed, the GUI management program 201 updates the graph in the area 292 (in particular, the predicted transition of values) on the basis of the parameter group in the screen 290 at the point in time at which the update button 296 was pressed. For example, the GUI management program 201 can store a history comprising multiple sets of parameter groups and numeric value transitions and update the graph (in particular, the predicted transition of values) on the basis of this history and the parameter group in the screen 290 at the point in time at which the apply button 295 was pressed.

In this example, it is possible to change the parameter for each item of each mode, but as described hereinabove, the parameter of at least one item may be fixed (unable to be changed by the user) with respect to at least one mode. Also, for example, the changing of the parameter once again by the user may be avoided in accordance with a parameter inputted by the user with respect to at least one mode being stored in a different area (hereinafter, the save area) than the mode management TBL, and this parameter group being read from the save area thereafter.

As described hereinabove, even a user who is unfamiliar with the specifications of the FM module 40F is able to change a parameter of the FM module 40F in accordance with selecting a mode.

The “specification” 506 shown in the mode management TBL 203 is not associated beforehand with an item and parameter like the above-mentioned modes (the performance priority mode, the balance priority mode, and the life priority mode). For the “specification”, the user can freely configure the values of an item (“RF interval”, “RC acceleration type”, “number of RC upper-limit blocks”, and “number of RC lower-limit blocks”) and a parameter. That is, in this example, the user is able to indirectly as well as directly configure an item and a parameter for controlling a RG in accordance with selecting a mode.

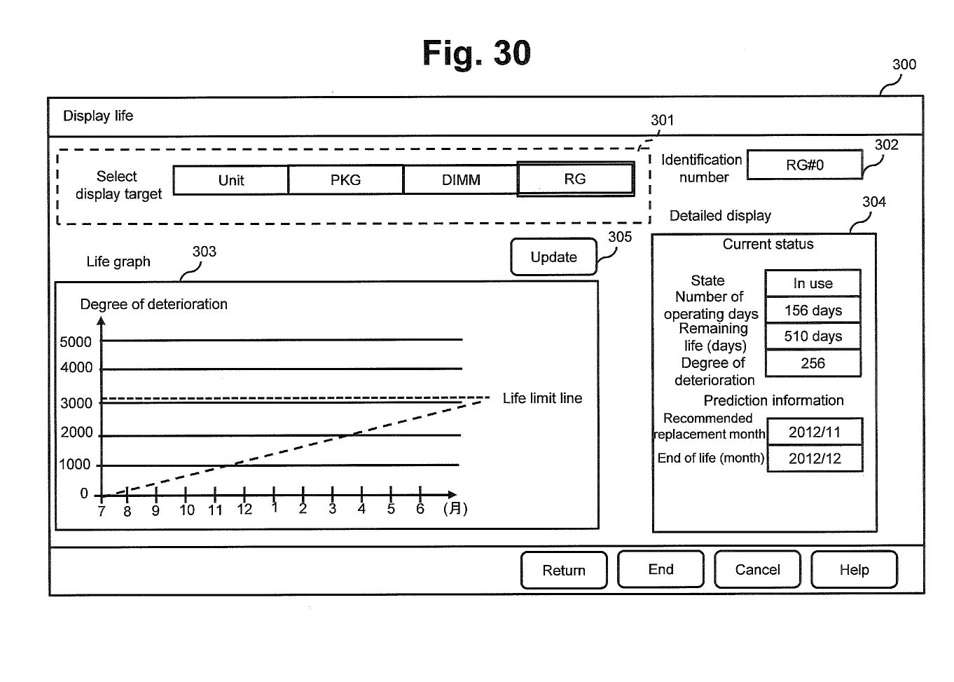

FIG. 30 shows an example of a life display screen 300.

The life display screen 300 is a third example of the GUI 14, and is a screen for displaying a life computed by the life computation program 202 on the basis of the log information. The life display screen 300 comprises a display target selection area 301, an identification number area 302, a life graph 303 area, and a detailed display area 304. The life display screen 300 may be displayed in a case where “life” is selected in the graph display area 292 of the mode change screen 290, and, in addition, the apply button 295 is pressed.

The display target selection area 301 is the area for selecting the unit to be used to display the graph displayed in the life graph area 303. As the display unit, there is a “Unit” (a set of multiple FMPKGs), a “PKG”, a “DIMM”, and a “RG”, and in the example of the drawing “RG” is selected from among the multiple display units.

Information for identifying the unit for the graph displayed in the life graph area 303 is input in the identification number area 302. In the example shown in the drawing, the display unit “RG” has been selected, and as such, the ID of the RG is inputted in the area 302.

A graph related to the life of the identification information unit (for example, the RG #0) inputted in the area 302 is displayed in the life graph area 303. In the example shown in the drawing, the horizontal axis is the time (for example, months). The graph denotes the transition of the degree of deterioration (for example, the number of Bad blocks (blocks in which a failure has occurred, or blocks for which the number of erases has exceeded an upper limit). The life computation program 202 can predict the transition of the degree of deterioration (how far the degree of deterioration will advance over what period of time) based on the log information, and can compute the point in time at which the predicted degree of deterioration will exceed the lifetime limitation (the Bad block limit value) as the life. The number of Bad blocks may be included in the log information, or the number of Bad blocks may be identified from the log information.

The current status of the unit (for example, RG #0) specified in the area 302, the number of days in operation, the remaining life, and the remaining life in accordance with degree of deterioration are displayed in the current status area 304. In addition, a “recommended replacement month” and an “end-of-life month” in this unit are displayed in the prediction information. The “end-of-life month”, for example, is the month to which the above-mentioned computer life belongs, and the recommended replacement month is a prescribed period of time prior to the end-of-life month (for example, one month prior).

By looking at this screen 300 or the areas 292 and 294 of the screen 290 shown in FIG. 29, the user is able to determine which mode has been selected for which RG, and what value should be assigned to what item parameter with respect to the selected mode.

Instead of predicting the remaining life based on the transition of the degree of deterioration, as was explained hereinabove, the time it takes for the number of log PEs to reach the number of PEs upper limit may be computed as the remaining life based on (p) the upper limit of the number of PEs of the FM package 40F (the upper limit of the number of erases), (q) the transition of the number of log PEs of this FM package 40F (for example, the cumulative value of the number of log PEs), and (r) the amount of change in the number of log PEs of this FM package 40F.

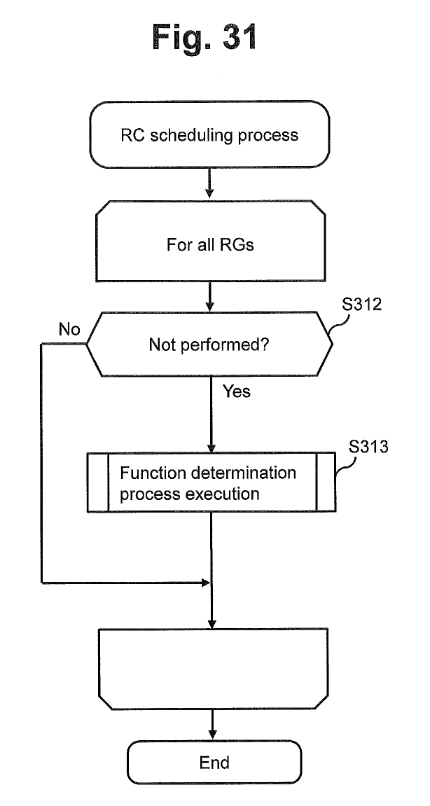

FIG. 31 shows an example of the flow of a RC scheduling process.

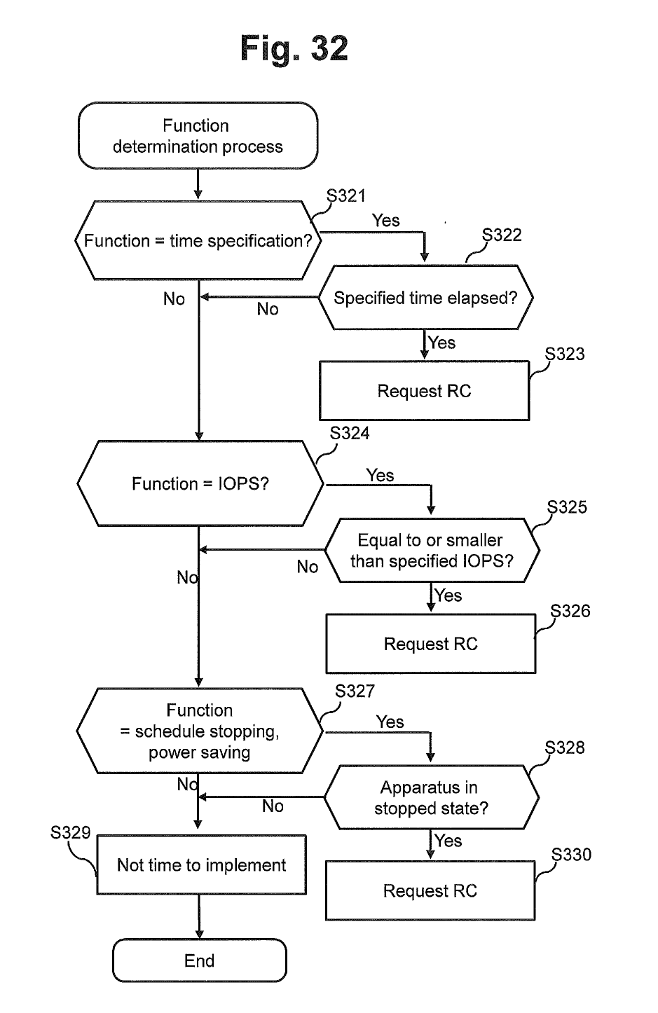

The RC schedule control program 302 executes S312 with respect to all the RG #s registered in the schedule management TBL 304. One RG (referred to as the “target RG” in the explanations of FIGS. 31 and 32) will be taken as an example below.

The RC schedule control program 302 checks whether or not the RC scheduling process for the target RG has yet to be processed.

In a case where the RC scheduling process for the target RG has not been processed (S312: Yes), the RC schedule control program 302 executes a function determination process (S313).

FIG. 32 shows an example of the flow of processing of S313 (the function determination process) of FIG. 31.

The RC schedule control program 302 references the function 905 of the schedule management TBL 304, and checks whether or not the function 905 is “time specification” (S321).

In a case where the function 905 is the “time specification” (S321: Yes), the RC schedule control program 302 checks whether or not the current time (the time denoted by the timer 33) exceeds the specified time (the time denoted by the date 906) (S322).

In a case where the current time exceeds the specified time (S322: Yes), the RC schedule control program 302 sends a request to perform a RC process (hereinafter, RC request) to each FM package 40F comprising the target RG (S323).

Alternatively, in a case where the function 905 is not the “time specification” (S321: No), the RC schedule control program 302 checks whether or not the function 905 is “TOPS” (S324). Even in a case where the current time does not exceed the specified time (S322: No), the RC schedule control program 302 checks whether or not the function 905 is “TOPS” (S324).

In a case where the function 905 is not “TOPS” (S324: No), the RC schedule control program 302 checks whether or not the function 905 is “stop schedule, save power” (S327).

In a case where the function 905 is “TOPS” (S324: Yes), the RC schedule control program 302 checks whether or not the IOPS is equal to or smaller than a scheduled IOPS (TOPS 907) (S325). In a case where the TOPS exceeds the scheduled IOPS (S325: No), the RC schedule control program 302 checks whether or not the function 905 is “stop schedule, save power” (S327).

In a case where the TOPS is equal to or smaller than the specified IOPS (S325: Yes), the RC schedule control program 302 sends a RC request to each FM package 40F comprising the target RG (S326). This is an example of a case in which a FM module 40F with a low load is made to execute the RC process. This makes it possible to execute the RC process while lessening the drop in performance of the FM module 40F.

In a case where the function 905 is “stop schedule, same power” (S327: Yes), the RC schedule control program 302 checks whether or not the FM package 40F is in the stopped state.

In a case where the FM package 40F is in the stopped state (S328: Yes), the RC schedule control program 3020 sends an RC request to each FM package 40F comprising the target RG (S330).

In a case where the FM package 40F is not in the stopped state (S328: No), the RC schedule control program 302 determines that it is not time to perform the RC process and ends the processing (S329).

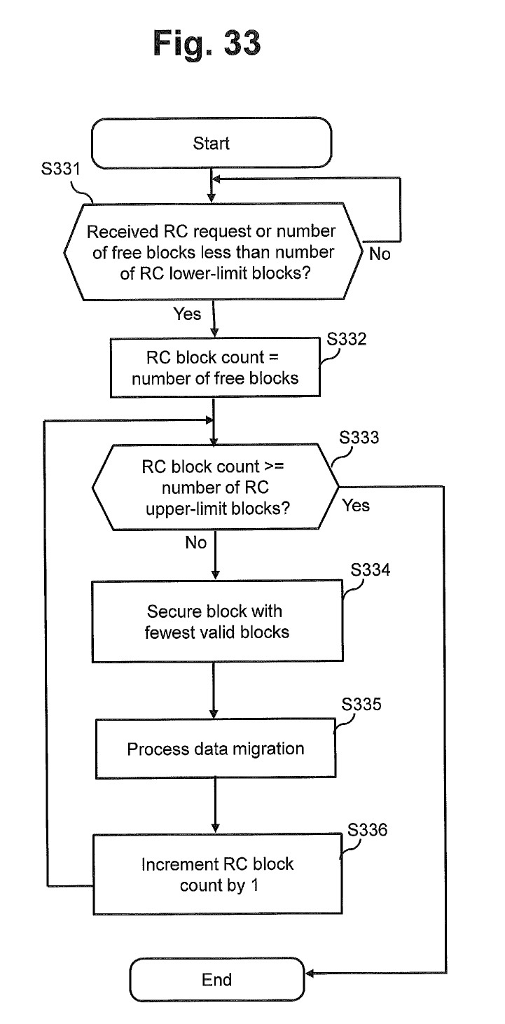

FIG. 33 shows an example of the flow of a RC process by the FM controller 45. In the explanation of FIG. 33, the FM package 40F comprising this FM controller 45 will be called the “target FM package 40F”.

The RC process is started either when the FM controller 45 detects that the number of free blocks in the target FM package 40F has dropped below the number of RC lower-limit blocks 1205 (refer to FIG. 12), or when the FM controller 45 has received a RC request from the storage controller 30. That is, the target FM package 40F starts the RC process upon receiving a RC request even when the number of empty blocks has not dropped below the number of RC lower-limit blocks 1205. This corresponds to the acceleration of the RC process.

The FM package control program 401 configures a first count value (the RC block count hereinafter) in the number of free blocks in the target FM package 40F (S332).

The FM package control program 401 checks whether or not the RC block count is equal to or larger than the number of RC upper-limit blocks 1204 (S333).

In a case where the RC block count is equal to or larger than the number of RC upper-limit blocks 1204 (S333: Yes), the FM package control program 401 ends the RC processing. That is, the FM package control program 401 may end the RC processing without performing RC in a case where the number of free blocks is equal to or larger than the number of RC upper-limit blocks 1204 at the point in time at which the RC request was received.

In a case where the RC block count is less than the number of RC upper-limit blocks 1204 (S333: No), the FM package control program 401 secures a block having the fewest valid pages from among one or more used blocks (blocks in which data is written down to the last page) (S334).

The FM package control program 401 migrates all the valid pages in the block secured in S334 (the migration-source block) to another block (either a free block or an in-use block), and erases the data from the migration-source block (S335). In accordance with this, the migration-source block becomes a free block. The in-use block is a block in which data is written to at least the first page, but data is not written to the last page.

The FM package control program 401 increments the RC block count by 1 (S336). Thereafter, S333 is performed once again.

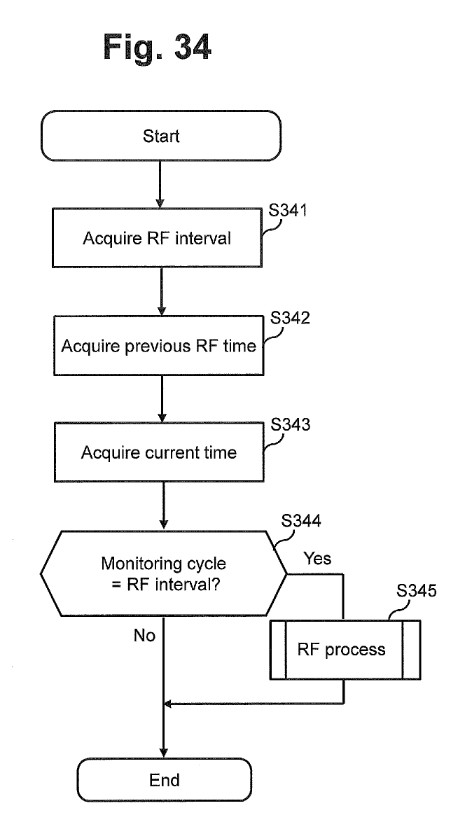

FIG. 34 shows an example of the flow of a RF cyclical execution process by the FM controller 45. In the explanation of FIG. 34, the FM package 40F comprising this FM controller 45 will be referred to as the “target FM package 40F”.

The FM package control program 401 acquires the RF interval 1202 from the FM package configuration information management TBL 402 (S341).

The FM package control program 401 acquires a previous RF time, which is the time at which the previous RF process was performed (S342), and also acquires the current time (S343). The FM package control program 401 computes a monitoring cycle, which is the time from the previous RF time until the current time. The RF time is stored in the memory 42 by the FM package control program 401 each time a RF process is performed, and as such, the previous RF time may be identified from the memory 42.

The FM package control program 401 checks whether or not the computed monitoring cycle has reached the RF interval 1202 acquired in S341 (S344). In a case where the monitoring cycle has reached the RF interval 1202 (S344: Yes), the FM package control program 401 performs RF processing (S345).

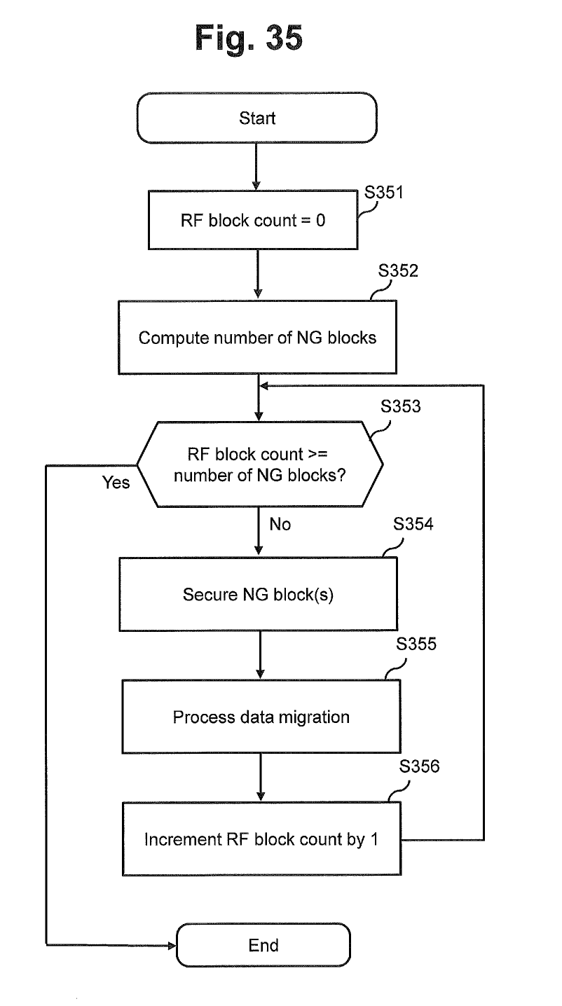

FIG. 35 shows an example of the flow of processing of S345 (RF process) of FIG. 34.

The FM package control program 401 configures a second count value (hereinafter, the RF block count) to 0 (zero) (S351).

The FM package control program 401 identifies the number of NG blocks (S352).

Specifically, for example, a NG block is a block in which subsequent to data being written to a prescribed page (for example, the first page) of this block, the data retention time elapses without an erase process being performed, and is a block, which stores valid data (the latest data for a certain logical block).

The FM package control program 401 checks whether or not the RF block count is equal to or larger than the number of NG blocks (S353).

In a case where the RF block count is less than the number of NG blocks (S353: No), the FM package control program 401 secures a NG block (S354).

The FM package control program 401 migrates the valid data from the NG block secured in S354 (the migration-source block) to another block (either a free block, or an in-use block, which is not a NG block), and erases the data from the migration-source block (S355). In accordance with this, the migration-source block becomes a free block.

The FM package control program 401 increments the RF block count by 1 (S356).

In a case where the RF block count has reached the number of NG blocks (S353: Yes), the NG blocks (that is, the blocks which have exceeded the data retention period) are done away with, and the RF processing ends.

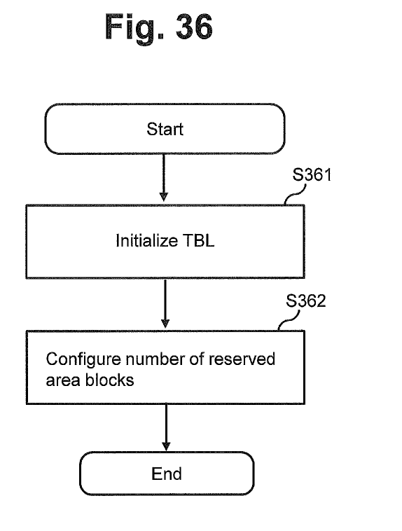

FIG. 36 shows an example of the flow of a reserved area setting process.

The FM package control program 401 initializes the FM package configuration information TBL 402 (S361).

The FM package control program 401, on the basis of the reserved capacity (or the reserved capacity ratio and the RG physical capacity), computes the number of reserved area blocks in a command received from the management computer 10 by way of the storage controller 30, and registers the computed value in the initialized TBL 402 as the number of reserved area blocks 1206 (S362).

The FM package manages, as the log information, the number of uncorrectable errors and a logical address and/or a physical address of either a page or a block in which an uncorrectable error occurred. An uncorrectable error, for example, is an error, which cannot be corrected using ECC or the like. As the triggers for detecting an uncorrectable error, there is a RC trigger, a RF trigger, and a read trigger. Since error correction is performed using ECC in the FM package at the time of a RC, a RF and a read, in a case where it is impossible to correct an error using the ECC, the FM package manages this data as an uncorrectable error.

In the case of an uncorrectable error, the data in a single FM package cannot be restored. However, in the case of a RAID group (RAID 5, 6 or the like) comprising multiple FM packages, the storage controller is able to use parity to restore the data in which the uncorrectable error occurred. For this reason, the FM package notifies the storage controller of the information related to the uncorrectable error. The notification may be performed on a regular basis, or may be performed when the total number of uncorrectable errors in the FM package is equal to or larger than a prescribed value. The FM package may also issue a notification about information related to an uncorrectable error in accordance with a request from the storage controller. The storage controller, which receives the notification, instructs that a data restoration be performed using parity, and that the restored data be written to a free area on the FM package.

When an uncorrectable error occurs in a certain FM package, and a failure or uncorrectable error also occurs in another FM package, data restoration becomes impossible. Since the uncorrectable error can be detected using an RC trigger and/or a RF trigger, shortening the RC interval and the RF interval enables an uncorrectable error to be detected promptly. This makes it possible to lower the possibility of data being lost.

### Example 2

Example 2 will be explained hereinbelow. In so doing, the points of difference with Example 1 will mainly be explained, and explanations of the points in common with Example 1 will be simplified or omitted.

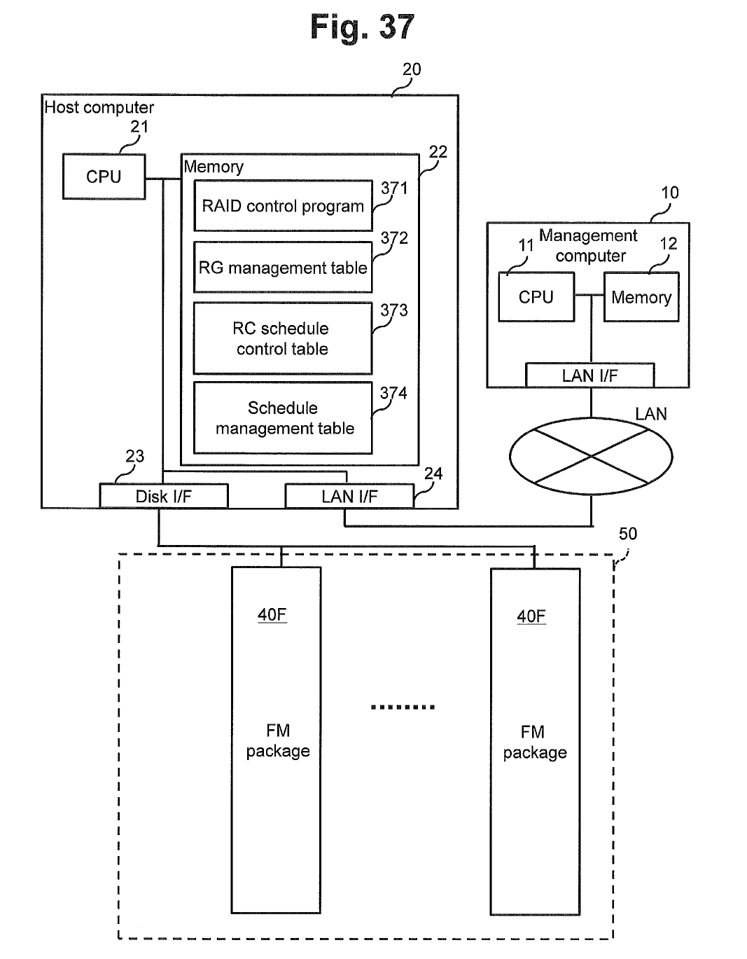

FIG. 37 shows an example of the configuration of a storage system related to Example 2.

In the storage system of Example 2, the device controller of the FM package 40F is a host computer 10. That is, the FM packages 40F are coupled to the host computer 20. The host computer 20 may comprise substantially the same functions as the storage controller of Example 1.

The memory 22 of the host computer 20 stores a RAID control program 371, a RG management TBL 372, a RC schedule control program 373, and a schedule management TBL 374.

The RAID control program 371 is for controlling access to an RG in accordance with the RAID level of the RG.

The other program and TBLs are each substantially the same as the elements of the same name explained in Example 1.

In Example 2, the number of FM modules 40F of the storage part 50 may be 1. In this example, the higher-level system of the FM module 40F may be a system comprising the host computer 20 and the management computer 10.

### Example 3

Next, Example 3 will be explained. In so doing, the points of difference with Example 1 will mainly be explained, and explanations of the points in common with Example 1 will be simplified or omitted.

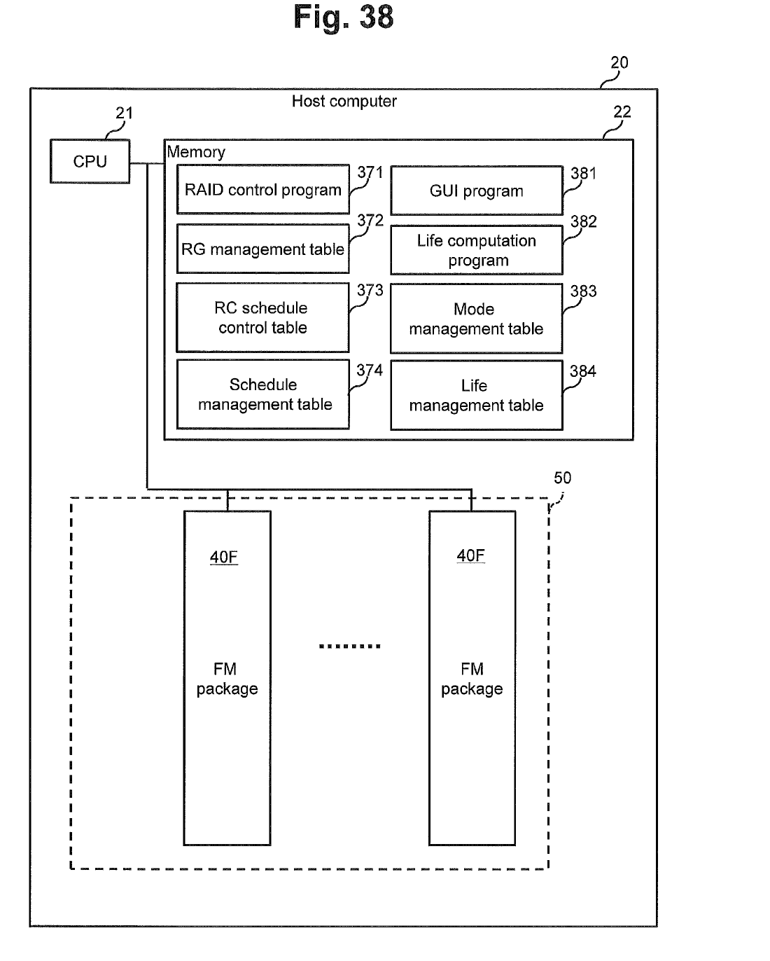

FIG. 38 shows an example of the configuration of a storage system related to Example 3.

The storage system of Example 3 is the host computer 20. That is, the FM package 40F is built into the host computer 20, and the device controller of the FM package 40F is the control device of the host computer 20, specifically, the CPU 21. The control device, in addition to the CPU 21, may comprise a hardware circuit for performing a prescribed process. In Example 3, the management computer 10 and the storage controller 30 are not necessary.

The memory 22 of the host computer 20 stores a RAID control program 371, a RG management TBL 372, a RC schedule control program 373, a schedule management TBL 374, a GUI management program 381, a life management program 382, a mode management TBL 383, and a life management TBL 384. These programs and TBLs are each substantially the same as the elements of the same name explained in Example 1 (and Example 2).

In Example 3, the number of FM modules 40F of the storage part 50 may be 1. The higher-level I/F of the FM module 40F may be an I/F (for example, a bus I/F like the I/F of PCI-Express) for communication with the CPU 21 instead of a Disk I/F. In this example, the higher-level system of the FM module 40F may be the CPU 21.

A number of examples have been explained hereinabove, but the present invention is not limited to these examples.

For example, the parameter group and/or the log information are not limited to units of RGs, and may exist in various device units, such as units of FM packages 40F and units of DIMMs.

For example, a parameter stored in an apparatus (for example, at least one of the management computer 10, the storage controller 30, and the FM controller 45) may at the least be a parameter, from among the inputted parameter group, required in the processing performed by this apparatus.

The present invention is not limited to the FM package, and is also applicable to another type of nonvolatile semiconductor memory device.

In addition, the threshold (for example, the specified time or the specified IOPS) referenced by the higher-level system for determining whether or not the RC process in the RC schedule process is to start may be inputted by the user via a GUI, and may be decided by the higher-level system (for example, the management computer 10, the storage controller 30, or the host computer 20) of the FM module 40F on the basis of a user-inputted parameter (for example, the mode type or the RC acceleration type).

The higher-level system, such as the storage controller 30, after sending a RC request when the current time exceeds the above-mentioned specified time, may compute a new specified time in accordance with adding a prescribed time to this specified time, and may register the computed specified time in the table 304 as the date 906. The prescribed time may also be inputted by the user via a GUI as one of the parameters included in the parameter group. Instead of the above-mentioned specified time, the higher-level system may configure a RC interval as one of the parameters for the RC process.

### REFERENCE SIGNS LIST

10 Management computer
20 Host computer
30 Storage controller
40F FM package

1. A storage system, comprising:
a nonvolatile semiconductor storage device; and
a higher-level system coupled to the semiconductor storage device,
wherein the semiconductor storage device comprises:
a nonvolatile semiconductor storage medium; and
a medium controller, which is a controller that is coupled to the semiconductor storage medium, receives an I/O (Input/Output) command, and either writes or reads data to/from the semiconductor storage medium in accordance with the I/O command,
wherein:
(A) a parameter setting process comprising the following (a1) through (a4) is executed:
(a1) the higher-level system displaying a GUI (Graphical User Interface) for receiving a first parameter group, which is one or more parameters for controlling the processing of the semiconductor storage device;
(a2) the higher-level system storing a second parameter group, which is at least one of the parameters of the first parameter group inputted to the GUI;
(a3) the higher-level system creating a parameter setting command, which is a command comprising a third parameter group which is at least one of the parameters of the first parameter group, and sending the parameter setting command to the semiconductor storage device; and
(a4) the medium controller receiving the parameter setting command, and storing a fourth parameter group, which is at least one of the parameters of the third parameter group included in the parameter setting command,
(B) the higher-level system executes processing in accordance with at least one of the parameters of the stored second parameter group;
(C) the medium controller executes processing in accordance with at least one of the parameters of the stored fourth parameter group;
(D) a log provision process comprising the following (d1) and (d2) is executed on either a regular or irregular basis:
(d1) the medium controller sending, to the higher-level system, a first log information comprising a first log, which is one or more types of logs related to processing executed in accordance with at least one of the parameters of the stored fourth parameter group; and
(d2) the higher-level system receiving the first log information, and storing a second log group, which is based on the first log group included in the first log information, and
(E) the higher-level system displays feedback information, which is information based on multiple second log groups, which have been stored, and
the (A) is performed with respect to a user-desired parameter of the first parameter group after the (E).

2. A storage system according to claim 1, wherein the semiconductor storage medium is a type of storage medium, which comprises multiple blocks, each block comprising multiple pages, and data being read/written in units of pages and erased in units of blocks,
the first and second log groups each comprise the number of erases,
the feedback information comprises a remaining life of the semiconductor storage device, and
each of the first through fourth parameter groups comprises at least one parameter, which influences the number of erases of the semiconductor storage device.

3. A storage system according to claim 2, wherein in a case where the number of free blocks is less than a lower limit value, the semiconductor storage device performs a reclamation process, which is a process for migrating valid data between blocks and erasing data from a migration-source block,
the second parameter group comprises a RC threshold, which is a threshold related to a trigger for starting the reclamation process,
in the (B), the higher-level system identifies a value to be compared to the RC threshold, compares the identified value to the RC threshold, and in a case where the result of the comparison satisfies a prescribed condition, sends a reclamation request which is a request to execute the reclamation process, to the semiconductor storage device, and
in the (C), upon receiving the reclamation request, the medium controller performs the reclamation process even in a case where the number of free blocks in the semiconductor storage medium is not less than the lower limit value.

4. A storage system according to claim 3, wherein the RC threshold is an access load threshold of the semiconductor storage device, and
in the (B), the higher-level system sends the reclamation request in a case where the access load of the semiconductor storage device is equal to or less than the RC load based on the result of the comparison.

5. A storage system according to claim 3, wherein the lower limit value is a parameter included in each of the first through fourth parameter groups.

6. A storage system according to claim 3, wherein in a case where the number of free blocks is equal to or larger than an upper limit value, the medium controller does not perform the reclamation process even after receiving the reclamation request, and ends the reclamation process in a case where the number of free blocks reaches the upper limit value during the reclamation process, and
the upper limit value is a parameter included in each of the first through fourth parameter groups.

7. A storage system according to claim 2, wherein in a case where there is a block for which a retention time from when data is stored until data is erased has reached a fixed time period, the semiconductor storage device performs a refresh process for migrating data in this block to another block and erasing data from a migration-source block,
at least the fourth parameter group comprises a RF interval, which is a cycle for performing the refresh process, and
the medium controller performs the refresh process at the RF interval included in the fourth parameter group.

8. A storage system according to claim 1, comprising:
multiple RAID (Redundant Array of Independent (Inexpensive) Disks) groups,
wherein each RAID group comprises multiple semiconductor storage devices,
the GUI displayed in the (a1) is a GUI for receiving a user-desired RAID group specification and a first parameter group for the specified RAID group, and
a destination of the parameter setting command of the (a3) is all the semiconductor storage devices forming the user-desired RAID group.

9. A storage system according to claim 8, wherein the first log group with respect to the RAID group is acquired for each semiconductor storage device forming this RAID group, and
the second log group with respect to the RAID group is based on the multiple first log groups respectively corresponding to multiple semiconductor storage devices forming this RAID group.

10. A storage system according to claim 1, wherein the higher-level system comprises:
a device controller, which is a controller that is coupled to the semiconductor storage device, and sends the I/O command to the semiconductor storage device; and
a management system, which is coupled to the device controller and communicates with the device controller,
wherein the GUI is displayed by the management system, and
the parameter setting command is sent by the device controller.

11. A storage control method, which is performed by a system comprising:
a nonvolatile semiconductor storage device, which comprises a non-volatile semiconductor storage medium and a medium controller, which is a controller coupled to this semiconductor storage medium; and a higher-level system coupled to the semiconductor storage device, the storage control method comprising the steps of:
(A) executing a parameter setting process comprising the following (a1) through (a4):
(a1) the higher-level system displaying a GUI (Graphical User Interface) for receiving a first parameter group, which is one or more parameters for controlling the processing of the semiconductor storage device;
(a2) the higher-level system storing a second parameter group, which is at least one of the parameters of the first parameter group inputted to the GUI;
(a3) the higher-level system creating a parameter setting command, which is a command comprising a third parameter group which is at least one of the parameters of the first parameter group, and sending the parameter setting command to the semiconductor storage device; and
(a4) the medium controller receiving the parameter setting command and storing a fourth parameter group, which is at least one of the parameters of the third parameter group included in the parameter setting command,
(B) the higher-level system executing processing in accordance with at least one of the parameters of the stored second parameter group;
(C) the medium controller executing processing in accordance with at least one of the parameters of the stored fourth parameter group;
(D) executing a log provision process comprising the following (d1) and (d2) on either a regular or irregular basis:
(d1) the medium controller sending, to the higher-level system, a first log information comprising a first log, which is one or more types of logs related to processing executed in accordance with at least one of the parameters of the stored fourth parameter group; and
(d2) the higher-level system receiving the first log information and storing a second log group, which is based on the first log group included in the first log information, and
(E) the higher-level system displaying feedback information, which is information based on multiple second log groups, which have been stored, and
performing the (A) with respect to a user-desired parameter of the first parameter group after the (E).

12. A storage control method according to claim 11, wherein the semiconductor storage medium is a type of storage medium, which comprises multiple blocks, each block comprising multiple pages, and data being read/written in units of pages and erased in units of blocks,
the first and second log groups each comprise the number of erases,
the feedback information comprises a remaining life of the semiconductor storage device, and
each of the first through fourth parameter groups comprises at least one parameter, which influences the number of erases of the semiconductor storage device.

13. A storage control method according to claim 12, wherein in a case where the number of free blocks is less than a lower limit value, the semiconductor storage device performs a reclamation process, which is a process for migrating valid data between blocks and erasing data from a migration-source block,
the second parameter group comprises a RC threshold, which is a threshold related to a trigger for starting the reclamation process,
in the (B), the higher-level system identifies a value to be compared to the RC threshold, compares the identified value to the RC threshold, and in a case where the result of the comparison satisfies a prescribed condition, sends a reclamation request which is a request to execute the reclamation process, to the semiconductor storage device, and
in the (C), upon receiving the reclamation request, the medium controller performs the reclamation process even in a case where the number of free blocks in the semiconductor storage medium is not less than the lower limit value.

14. A storage control method according to claim 13, wherein the RC threshold is an access load threshold of the semiconductor storage device, and
in the (B), the higher-level system sends the reclamation request in a case where the access load of the semiconductor storage device is equal to or less than the RC load based on the result of the comparison.

15. A storage control method according to claim 13, wherein the lower limit value is a parameter included in each of the first through fourth parameter groups.
